(19) United States
(12) Patent Application Publication
(10) Pub. No.: US 2013/0179308 A1
(43) Pub. Date: Jul. 11, 2013

(54) Methods and Systems Related to Monetization Plug-Ins in Interactive Multimedia Applications

(71) Applicants: Michael A. AGUSTIN, San Francisco, CA (US); William R. GARRETSEN, Cedar Park, TX (US); Sushmita SUBRAMANIAN, San Francisco, CA (US); Daniel L. TREIMAN, Round Rock, TX (US)

(72) Inventors: Michael A. AGUSTIN, San Francisco, CA (US); William R. GARRETSEN, Cedar Park, TX (US); Sushmita SUBRAMANIAN, San Francisco, CA (US); Daniel L. TREIMAN, Round Rock, TX (US)

(73) Assignee: GAMESALAD, INC., Austin, TX (US)

(21) Appl. No.: 13/346,900

(22) Filed: Jan. 10, 2012

(51) Int. Cl. G06Q 30/00

(52) U.S. Cl. 705/27.1

(57) ABSTRACT

Monetization plug-ins in interactive multimedia applications. At least some of the illustrative embodiments are methods including: accepting an indication of flow of an interactive application configured to selectively implement an in-application purchase, the accepting by way of a graphical user interface (GUI); creating a representation of the flow of the interactive application, the representation at least partially in a declarative format; and executing the interactive application by a first runtime engine, the first runtime engine becomes executable code that implements the in-application purchase.

### CROSS-REFERENCE TO RELATED APPLICATIONS

This application is related to patent application Ser. No. 13/033,408, filed Feb. 23, 2011, titled “Methods and Systems Related to Creation of Interactive Multimedia Applications,” which patent application is incorporated by reference herein as if reproduced in full below.

### BACKGROUND

Interactive multimedia applications, such as computer games, have become a major market component in the world economy. The electronic game markets comprise not only massive online multi-player games and console games, but also games for portable multi-function computing devices such as iPhone® and iPad® brand devices available from Apple, Inc. of Cupertino, Calif.

Interactive multimedia application creation is a highly creative art, and as such is attractive to those with creative personality types. On the other hand, computer programming has generally been the domain of logical, methodical personalities, who view the world as a discrete series of steps. While in some cases the highly creative personality will coincide with the highly logical personality, in most cases the abilities do not reside fully in a single individual. For that reason, many highly creative people find it difficult to write source code for programming of interactive multimedia applications.

Additionally, it can be difficult for developers to earn revenue from their applications and games. Traditionally, developers generated revenue through sales of the application or game itself. However, if a developer created a free game, there was virtually no way for him to generate revenue. Thus, developers turned to alternative methods of monetization such as selling items or other game elements in the application, such as in-application purchases. Implementing in-application purchases requires the developer to be able to program a monetization system into the application; thus, either the developer must know how to write source code, or the developer must hire a programmer, cutting into any potential revenue.

Therefore, any advance which makes the programming easier, including the programming of monetization services, would provide a competitive advantage in the marketplace.

### BRIEF DESCRIPTION OF THE DRAWINGS

For a detailed description of exemplary embodiments, reference will now be made to the accompanying drawings in which:

FIG. 1 shows a block diagram of components used in interactive game creation in accordance with at least some embodiments;

FIG. 2 shows a block diagram of creation of executable deliverables of interactive games in accordance with at least some embodiments;

FIG. 3 shows a tree structure that logically depicts game organization in accordance with at least some embodiments;

FIG. 4 shows a tree structure that logically depicts various aspects of actors in accordance with at least some embodiments;

FIG. 5 shows a tree structure that logically depicts a representation of a game in a portable game format in accordance with at least some embodiments;

FIG. 6 shows an illustrative project editor view, in accordance with at least some embodiments;

FIG. 7 shows a portion of the project editor view when the manager tab is visible, in accordance with at least some embodiments;

FIG. 8 shows an illustrative scene editor view, in accordance with at least some embodiments;

FIG. 9 shows a portion of the scene editor view when the inspector area shows the game attributes view, in accordance with at least some embodiments;

FIG. 10 shows a portion of the scene editor view when the inspector area shows the game devices view, in accordance with at least some embodiments;

FIG. 11 an illustrative rule editor view, in accordance with at least some embodiments.

FIG. 12 shows a block diagram representation of a runtime engine in accordance with at least some embodiments;

FIG. 13 shows a method in accordance with at least some embodiments;

FIG. 14 shows a runtime engine communicating with a remote server, in accordance with at least some embodiments;

FIG. 15 shows an illustrative actor editor view, in accordance with at least some embodiments;

FIG. 16 shows an illustrative scene editor view, in accordance with at least some embodiments; and

FIG. 17 shows a computer system in accordance with at least some embodiments.

### NOTATION AND NOMENCLATURE

Certain terms are used throughout the following description and claims to refer to particular system components. As one skilled in the art will appreciate, different companies may refer to a component and/or method by different names. This document does not intend to distinguish between components and/or methods that differ in name but not function.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection or through an indirect connection via other devices and connections.

“In-application purchase” shall mean a transfer of monetary funds between living individuals and/or corporate entities in the real world, the transfer of monetary funds affects execution of an interactive application, such as a game.

“Remote,” with respect to the distance between two devices, shall mean one kilometer or more.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

The various embodiments are directed to an interactive multimedia application development platform. More particularly, at least some embodiments are directed a platform that enables “visual” (e.g., drag and drop) programming in a declarative programming style, including “visual” programming of in-application purchases. The various embodiments were developed in the context of the interactive multimedia applications being interactive multimedia computer games, and thus the specification is based on the developmental context; however, the developmental context shall not be read as limitation as to the scope of the various embodiments.

In implementing a monetization service within an application or game, a developer creates an in-application purchase behavior which includes information related to implementing the desired monetization service. The developer need only contribute the specific information used for the in-application purchase behavior, and need not know any programming to implement the behavior within the application; rather, the development platform implements the in-application purchase behavior for the developer. The specific information a developer needs to provide may include information such as an item description, a price, a unique identification number, and any other rules or behaviors associated with the in-application purchase behavior. The specification first turns to a high level description of the various software components associated with application creation.

Overview

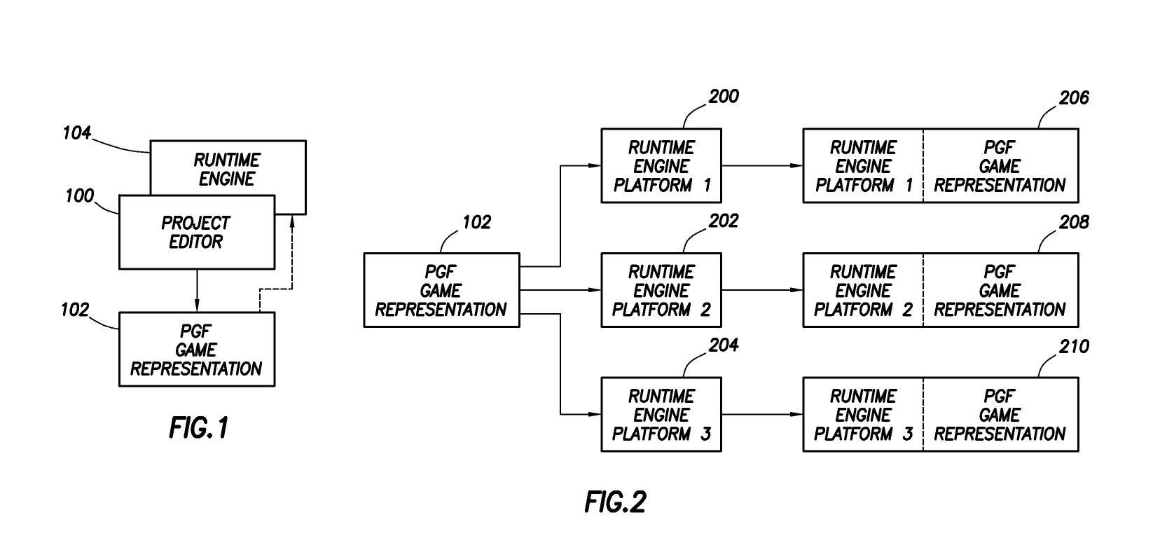

FIG. 1 shows, in block diagram form, a high level overview of the various components used in game creation in accordance with at least some embodiments. In particular, interactive games may be created and/or edited by way of a project editor 100. In a particular embodiment, the project editor 100 is a browser-based executable program, and in yet still other cases the project editor may be a standalone software package that executes on the computer system. In accordance with at least some embodiments, the project editor 100 enables creation and/or editing of a game visually, without the need to create source code. Various screens and functions of the project editor are discussed more below. The process of creating a game by interaction with the project editor 100 creates a representation of the game 102 in a format termed herein portable game format (PGF). Various attributes of PGF game representations will be discussed more below.

Still referring to FIG. 1, the project editor 100 is associated with a runtime engine 104. The runtime engine 104 reads the game 102 in the PGF game representation and configures itself to execute or play out the game, including creation of the visual aspects and reading data from input devices such as the keyboard, mouse, touch screen, accelerometers, and inclinometers. The project editor 100 is associated with the runtime engine 104 such that, at various times during the creation process, the player may run the game, or portions of the game, to evaluation game development and make decisions and/or changes in game play.

FIG. 1 illustrates the creation environment; however, in order to make the game available on different computer systems (i.e., different platforms), in some embodiments the PGF game representation is combined with a runtime engine configured for the specific computer system. FIG. 2 shows in block diagram form combining a PGF game representation with a runtime engine. In particular, FIG. 2 illustrates a game 102 in PGF game format, along with an illustrative three runtime engines 200, 202, and 204. Each runtime engine is specifically configured for a particular type of computer system. For example, runtime engine 200 may be configured for execution on an iPhone® brand product, runtime engine 202 may be configured for execution on an iPad® brand product, and runtime engine 204 may be configured for execution on a laptop or desktop computer systems (e.g., a computer system running a Windows® brand operating system available from Microsoft Corporation of Redmond, Wash.).

While a runtime engine may be or may become the executable code for a game, the runtime engine itself does not know or contain the game play; rather, to create a self contained product (i.e., a deliverable) for execution on a computer system, in some embodiments a particular runtime engine is packaged with the game 102 in the PGF game representation. In the example of FIG. 2, the game 102 in the PGF game representation is combined with the runtime engine 200 to create a deliverable 206 that will be executable on a first illustrative type of computer system. Likewise, the game 102 in the PGF game representation is combined with the runtime engine 202 to create a deliverable 208 that will be executable on a second illustrative type of computer system. Finally, the game 102 in the PGF game representation is combined with the runtime engine 204 to create a deliverable 210 that will be executable on a third illustrative type of computer system. As illustrated by FIG. 2, however, the combing to create the respective deliverables in accordance with a particular embodiment is a grouping of the game 102 and the respective engine 200, 202, and 204. In some cases, the combining is merely a logical grouping of the files that represent the game 102 and the file(s) that are the runtime engine such that the respective runtime engine knows the location and can read the files of the game 102. In a particular case, the combining is merely a concatenation of the various files into a single deliverable, but where the runtime engine and game are discernible portions. In some cases, for example on large games, the game 102 may be compressed, such that one of the first actions the runtime engine may take during execution is uncompressing the files that represent the game to a known location for reading and interpretation. Other mechanisms to create executable versions of the game may also be used, such as after-developed mechanisms.

Before proceeding, a particular point is highlighted. That is, in a particular embodiment each deliverable 206, 208, or 210 contains both executable code for the runtime engine and a representation of the game 102 in the PGF game format (e.g., direct representation, compressed version, encrypted version). In these embodiments, the game 102 is not “compiled” in the traditional sense before being provided to the computer system on which the game 102 will run. Moreover, unlike platform independent programming languages, a deliverable contains the runtime engine which interprets the game 102 in the PGF game representation. The specification now turns to game creation.

FIG. 3 illustrates a tree structure that logically depicts various aspects of game organization in accordance with at least some embodiments. In particular, FIG. 3 shows that a game 300 contains scenes. In the illustrative case of FIG. 3, game 300 contains three scenes 302, 304, and 306, but any number of scenes may be equivalently used, including “simple” games containing only one scene. Scenes may take place in any order. Within each scene are actors. For example, scene 302 illustratively contains three actors 308, 310, and 312. In a particular embodiment, every object in scene is an actor. For example, consider a classic arcade-style game where the player controls direction and acceleration of a space ship, and also controls firing of laser pulses that strike and destroy asteroids. Not only is the space ship an actor, but each asteroid is an actor, and each laser pulse is an actor.

Actors are not limited to particular scenes, and in fact an actor may span multiple scenes. In the example of FIG. 3, actor 308 spans both scene 302 and scene 304. Likewise, an actor may reside within a single scene, such as illustrative actor 314 residing only in scene 304, and actor 316 residing only in scene 306.

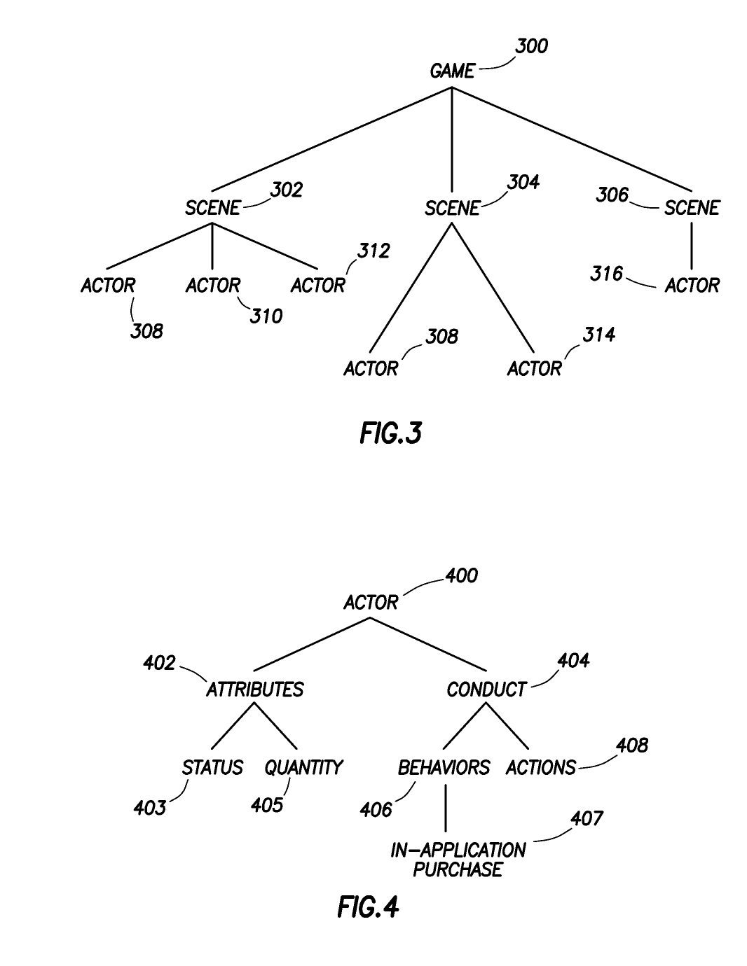

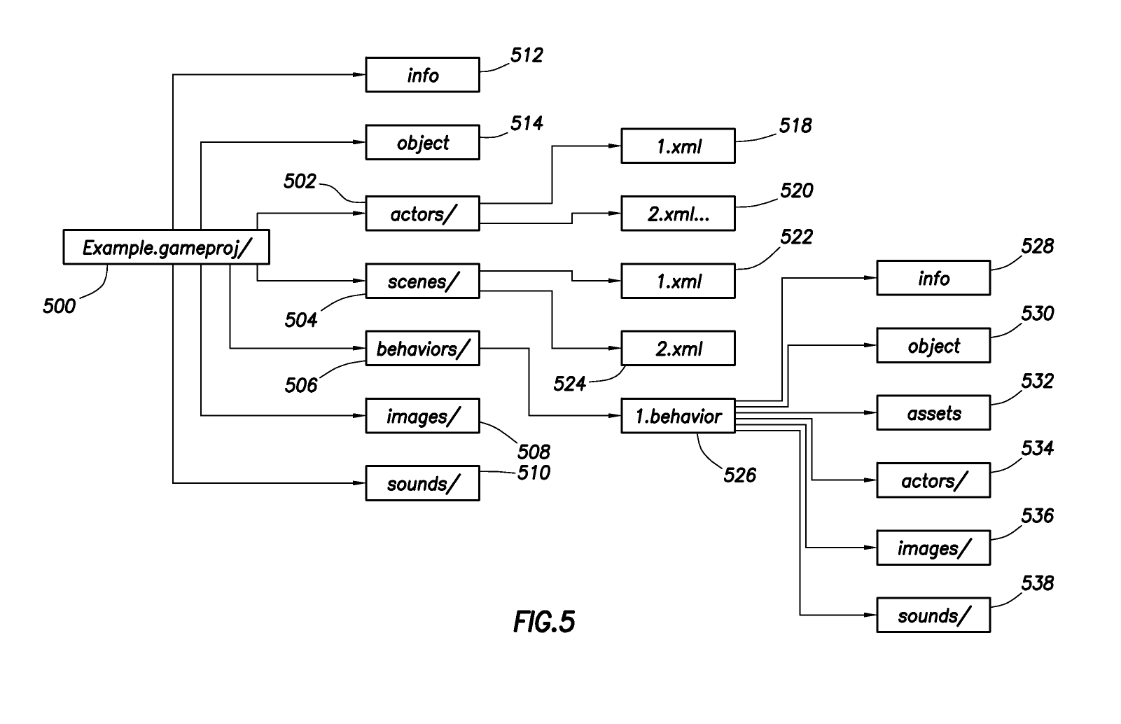

FIG. 4 illustrates a tree structure that logically depicts various aspects of an actor in accordance with at least some embodiments. In particular, FIG. 4 shows that an actor 400 is comprised of attributes 402 and conduct 404. Attributes 402 may define characteristics of the actor 400, such as initial position in the scene, size of the actor, color, rotational angle, the name of an image rendered on a screen that represents the actor, visibility, an integer or real number quantity of items purchased or able to be purchased, or a Boolean representing whether an item has been purchased by the actor. Moreover, attributes 402 may define data about how the actor 400 acts or reacts in a physics sense.

In FIG. 4, conduct 404 of illustrative actor 400 may be considered to comprise both behaviors 406 and actions 408. In accordance with particular embodiments, when a behavior 406 is activated, the result is “persistent” or “continuous”. Consider, for example, the illustrative Accelerate behavior. The Accelerate behavior causes an actor to accelerate in a particular direction. In the example of the arcade-style asteroid game, the Accelerate behavior may be assigned to the space ship actor, and when the Accelerate behavior is activated (such as by pressing a key on an interface device), the space ship actor may then accelerate in a particular direction. The behaviors may also illustratively include a in-application purchase behavior 407, discussed more below.

By contrast, when an action 408 is activated, an “instantaneous” action takes place. Consider, for example, the illustrative Change Image action. The illustrative Change Image action changes an attribute 402 of the actor 400, and more particularly changes the image rendered to represent the actor. In the example of the arcade-style asteroid game, the player may purchase an invisibility item, triggering the Change Image action which may change the image rendered to represent the spaceship actor to a cloaked spaceship that is invisible on the screen, but still present within the scene.

PGF Game Representation

In a particular embodiment, the PGF game representation is a plurality of files that define aspects of the game, such as actors, scenes, and images rendered during the game. FIG. 5 shows an illustrative tree structure of a PGF game representation. In particular, FIG. 5 shows a block titled “Example.gameproj” 500. In some cases, the Example.gameproj 500 is a folder or directory of a file system within which the remaining files and directories are stored. In other cases, the Example.gameproj 500 is a theoretical construct used to form the base or root of the tree structure. The balance of the discussion will assume the Example.gameproj 500 is a folder. Within the folder 500 resides a plurality of other folders and files. In the example of FIG. 5, the folder 500 contains five additional folders, comprising the actors folder 502, the scenes folder 504, behaviors folder 506, images folder 508, and sounds folder 510. The illustrative folder 500 also contains files, comprising info file 512, and object file 514.

The info file 512 may contain information regarding the game represented in the PGF game representation, as well as information regarding the version of project editor 100 used to create the PGF game representation. In a particular embodiment, the info file 512 is coded in extensible markup language (XML); however, other coding schemes may be equivalently used, such as JavaScript Object Notation (JSON).

The object file 514 may contain information such as game play instructions, description of the game itself, a list of prototype actors (discussed more below), a list of scenes, as well as initial attributes of the game itself (e.g., name of the game, and display size on which the game will be played). In a particular embodiment, the object file 512 is coded in XML; however, other coding schemes may be equivalently used.

Within the actors folder 502 resides one or more files, such as the actor files 518 and 520 illustratively titled “1.xml” and “2.xml”, respectively. Each file in the actors folder 502 represents what the inventors refer to as “prototype actor.” Creation of actors within scenes, in accordance with particular embodiments, can be considered a two step process—first, a prototype actor is created, and then an actor is instantiated into a scene based on the prototype actor. However, instantiating an actor instance into the scene does not change or alter the prototype actor. Thus, the prototype actor may be used multiple times as the basis for creating actor instances within a scene. In the example of the space ship game, the game developer may create a prototype asteroid actor. The developer may then place several asteroid actors into each scene, with each asteroid actor instance being based on the prototype asteroid actor. As will be discussed more below, actors within the scenes can and do behave differently than their prototypes, but the prototype actor forms the initial basis for each actor instance within a scene.

Each actor file within the actors folder 502 contains information about a prototype actor. For example, an actor file may contain information such as the name of the prototype actor, an initial position of the prototype actor, the size of the prototype actor, an initial rotational orientation of the prototype actor, an initial color, an identification of an image which may rendered to represent the prototype actor, an initial linear velocity of the prototype actor, maximum linear velocity of the prototype actor, an initial angular velocity of the prototype actor, and physics-based properties of the prototype actor (e.g., density, friction, and collision shape).

Each prototype actor may also contain indications of the conduct 404 of the prototype actor. That is, each actor file may contain indications of behaviors and actions associated with the prototype actor. Consider again the asteroid game. For example, when a space ship actor collides with a supply station, an associated in-application purchase behavior may be initiated, enabling the space ship to purchase extra lives or a power boost. To implement functionality such as gaining the ability for the ship to accelerate from a purchased power boost, an illustrative prototype actor for the space ship combines a Rule behavior with an Accelerate behavior that is initiated when the in-application purchase behavior is implemented on the collision, enabling the ship to move faster.

Illustrative Table 1 below shows use of a Rule behavior as may be found in the PGF representation. The Rule behavior illustratively sets a rule such that when the mouse button is pressed, the in-application purchase behavior is enabled, allowing a purchase to be made, as well as creating the associated attributes and storing the updated information.

TABLE 1
<behavior enabled=“true” id=“id200841” class=“RuleBehavior”>

<attributes>

<text id=“name”>Rule</text>
<text id=“bundleName”>Rule.behavior</text>
<real id=“compoundConditionKind”>0</real>

</attributes>

<conditions>

<condition id=“id624786” pluginPredicateTypeIndex=“0”
eventType=“mouse button”>

<attributes>

<index id=“conditionType”>0</index>

</attributes>

<predicate mouseState=“down” type=“mouse”>
</predicate>

</condition>
<behaviors>

<behavior id=“id463787” class=“InAppPurchaseItemAction” enabled=“true”>

```
<attributes>
  <text id=“name”>In App Purchase Item</text>
  <text id=“bundleName”>InAppPurchaseItem.behavior</text>
  <text id=“itemIdentifier”>game.attributes.id679072</text>
  <text id=“targetAttribute”>game.attributes.id383616</text>
  <boolean id=“consumable”>false</boolean>
  <text id=“RHS”/>
  <text id=“successSceneKey”>id253999</text>
  <text id=“cancelSceneKey”>id481407</text>
  <text id=“errorSceneKey”>id363262</text>
</attributes>
```

</behavior>

</behaviors>
<elseBehaviors/>
</behavior>

Within the scenes folder 504 resides one or more files, such as the file 522 and 524 illustratively titled “1.xml” and “2.xml”, respectively. In a particular embodiment, each scene of the game has a respective file in the scenes folder 504. Thus, a first scene of the game may be represented by the scene file “1.xml”, a second scene of the game may be represented by the file titled “2.xml”, and so forth. However, in other embodiments the scenes may be contained in a single file. Each scene file contains a host of information about the scene. In a particular embodiment, the information within scene file 522 is coded in XML; however, other coding schemes may be equivalently used.

In addition to the information about the scene discussed above, each scene file may also contain information about the actor instances within the scene. As discussed above, each actor instance within a scene is based on a prototype actor. Each actor instance within a scene initially has all the attributes 402 and conduct 404 of its respective prototype actor, but the actor's attributes and conduct may change during the game, and the changes in attributes and conduct are not reflected in changes to the respective prototype actor. For example, actor instances may inherit in-application purchase behaviors from a prototype actor, but each actor may be slightly different or significantly different even though they are each based on the same prototype actor. For example, in a space ship game, the prototype actor may have the in-application purchase behavior which initiates when the space ship actor collides with a supply ship, enabling the player to purchase additional lives. An actor instance in the scene, therefore, may inherit this prototype actor behavior, enabling the purchase of additional lives upon a collision, whereas another actor instance in the same scene may have the inheritance of the in-application behavior broken. In this example, an actor that has had inheritance of the in-application purchase behavior of prototype actor broken will not have the ability to make a purchase upon colliding with a supply ship.

Still referring to FIG. 5, within the images folder 508 reside various images that are or may be used during game play. More particularly, the images that are rendered are stored in the images folder 508. For example, the images folder 508 may store a bitmap image of a space ship that is identified as the image with respect to a space ship actor in a scene. As yet another example, the images folder 508 may contain the successive images used by the Animate behavior.

Within the sounds folder 510 reside various sound files that are or may be used during game play. For example, the Play Music action may play a sound file stored in the sounds folder 510. Likewise, the Play Sound action may play a sound file stored in the sounds folder 510.

Within the behaviors folder 506 may reside a file system element 526 illustratively titled “1.behavior”. In a particular embodiment, behaviors and/or actions may be grouped to form pre-packaged behavior sets or behavior bundles. The prepackaged behavior sets may then be quickly and easily applied to prototype actors, or to actors instantiated within a scene. In these embodiments, the behavior bundles may be stored within the PGF game representation in the behaviors folder 506. In some cases, the illustrative “1.behavior” file system element 526 may be a file, coded in any suitable format, which defines the behavior bundle. In other cases, the illustrative “1.behavior” file system element 526 is a folder within which other files and folders may reside. For example, in the case where file system element 526 is a folder, the folder may contain files such as an information file 528, object file 530, and assets file 532. These files may perform a similar function to the info file 512, object file 514, and assets file 516 discussed above, but directed to the particular behavior bundle rather than the entire game. The files 528, 530, and 532 may be coded in any suitable form, such as XML. Moreover, where the file system element 526 is a folder, the actors folder 534, images folder 536, and sounds folder 538 may perform a similar function as the actors folder 502, images folder 508, and sounds folder 510 discussed above, but limited to the particular behavior bundle rather than the entire game.

A few points should be highlighted before proceeding. While it is possible for a game developer to manually code the use of any of the attributes, as well as any of the behaviors and actions noted in the section below titled “BEHAVIORS AND ACTIONS”, in accordance with at least some embodiment the game developer creates the game by interaction with a graphical player interface of the project editor in a drag and drop style (e.g., a prototype actor is drug and dropped into a scene, thereby instantiating the actor in the scene based on the prototype actor). Thus, in a particular embodiment it is the programs that implement the project editor 100 that create and manipulate the files noted with respect to the PGF game representation. Next, the illustrative XML in the tables above and below are not executable code and shall not be considered source code. However, when read by an execution engine, the PGF game representation is all that the runtime engine needs to implement the behaviors and actions of the actors within the scenes. The specification now turns to various graphical player interfaces of the project editor 100.

Project Editor

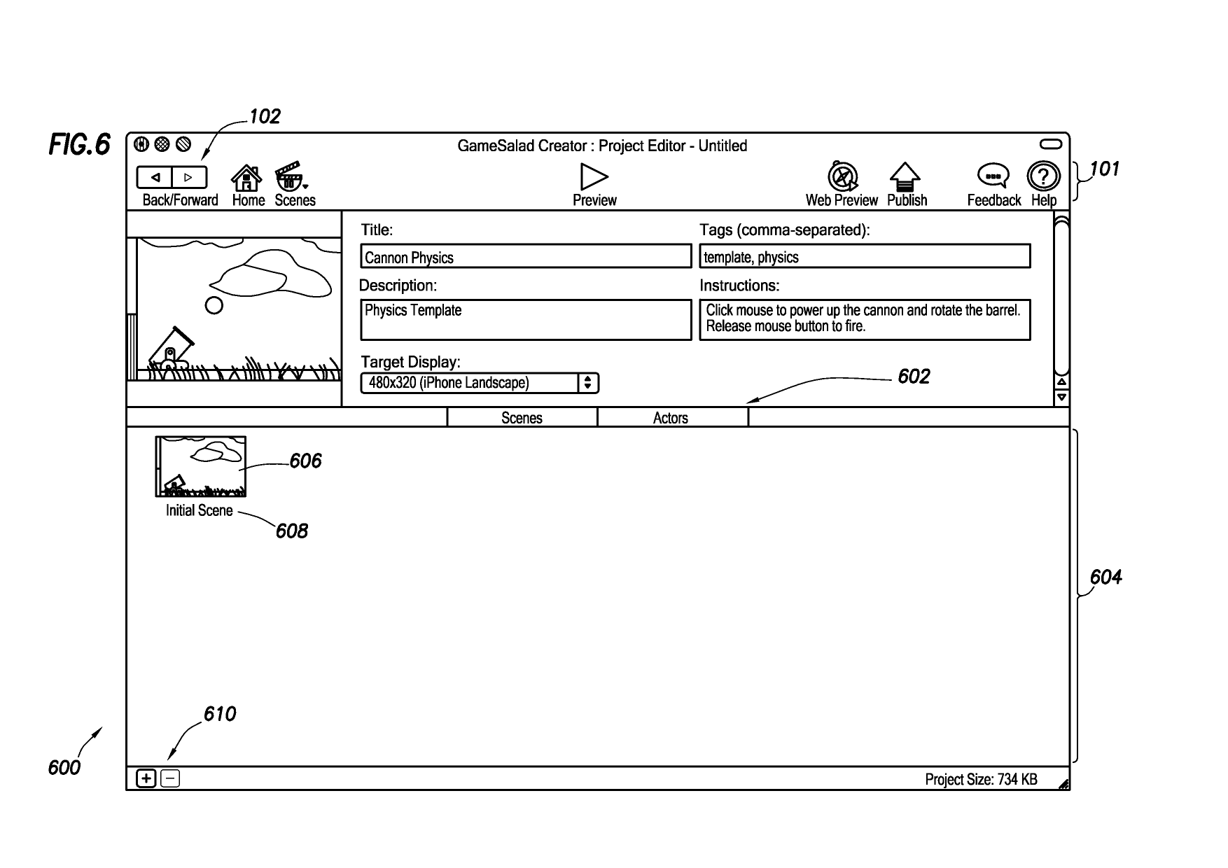

In accordance with particular embodiments, game development takes place by interaction with a series graphical interfaces. The discussion begins with the project editor view. The first view a game developer may see when using the application is the project editor view 600 as shown in FIG. 6. The project editor view 600 provides a location to supply descriptive data about project including the project name, a description, categorical tags, icon or screenshot. Below the descriptive information is a tabbed interface 602 that enables game developers to select between managing scenes and/or actors.

When the scene manager tab 604 is visible, game developers can see screenshot thumbnail images that represent the scene, such as screenshot 606, or if no screenshot thumbnail image has been designated a generic icon. If a game developer double clicks on the screenshot thumbnail image of scene, the interface switches to the scene editor view, discussed more below. At the bottom of the project editor view 600 are two buttons 610 labeled with plus and minus signs, which enable the game developer to add new scenes or to remove the selected scenes.

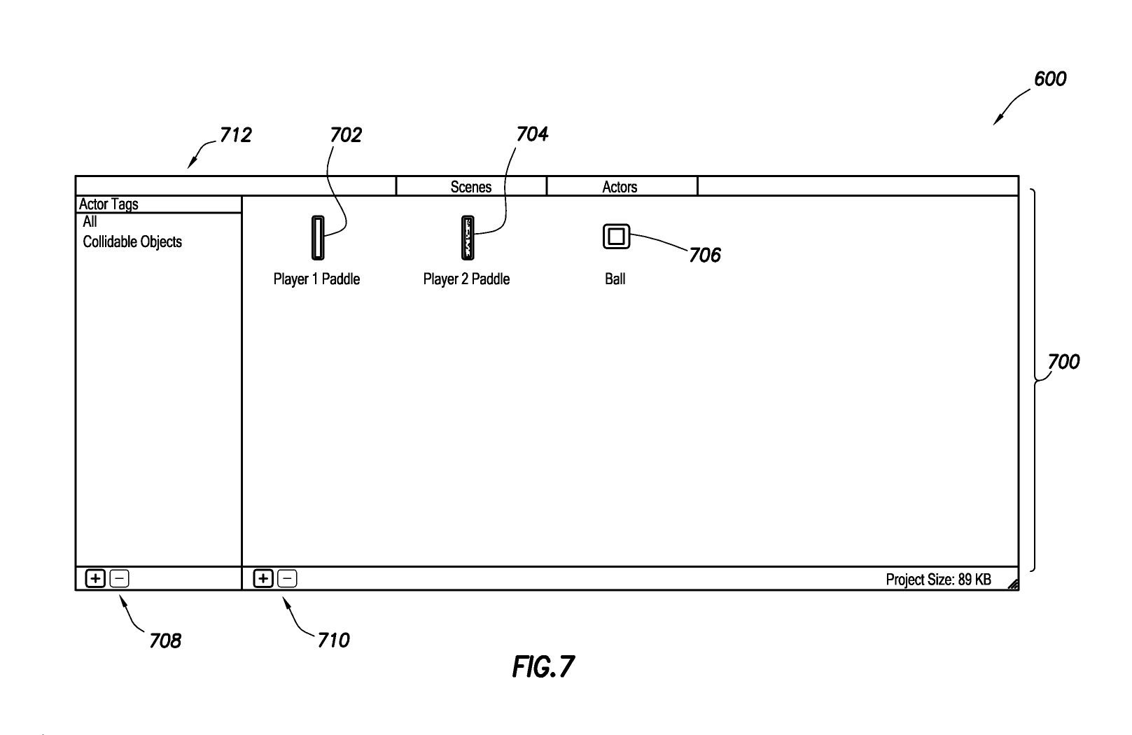

FIG. 7 shows a portion of the project editor view 600 when the actor manager tab 700 is visible. In particular, when the actor manager tab 700 is visible, a game developer sees thumbnail images for each prototype actor. A game developer may edit the name of a prototype actor or edit the actor itself by double clicking on the thumbnail image to switch to the actor editor view, discussed more below. At the bottom of the interface are two sets of buttons 708 and 710, each set of buttons comprising a plus sign button and minus sign button. The sets of buttons 710 enable the game developer to add new or remove actors. The sets of buttons 708 enable the game developer to add new or remove tags.

As seen in FIG. 7, a developer creates a prototype actor by dragging and dropping a behavior element into the window. In the illustrative case of an in-application purchase behavior, the developer then inputs any and all information used to initiate and execute the purchase, such as the name of an item, a unique identifying number, a description, a price, and any possible behavior elements that will trigger the in-application purchase behavior.

Scene Editor

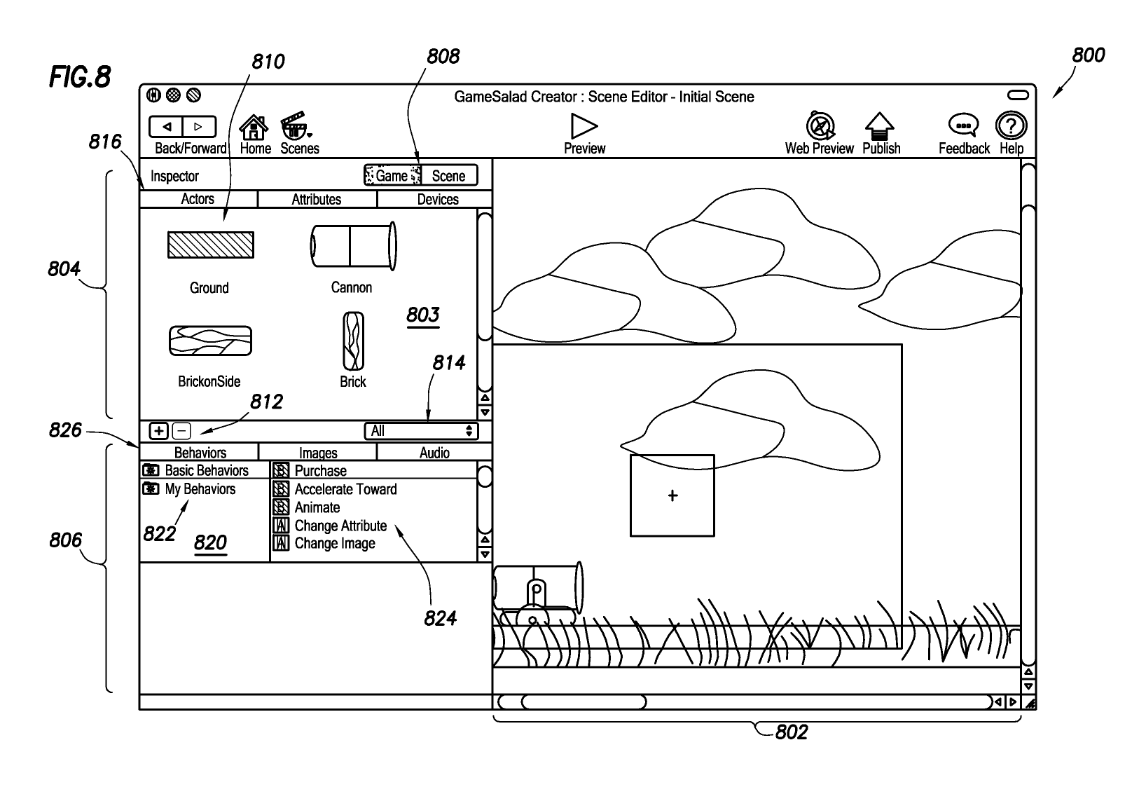

Another view a game developer may see is the scene editor view 800 as shown in FIG. 8. In particular, the scene editor view 800 enables the game developer to layout the initial position of actor instances in the scene, set how the view port or camera is controlled, and preview and interact with the scene by way of the runtime engine 104 associated with the project editor 100. Runtime interaction enables a game developer to have a more tactile feel for how the game runs, as well as enabling testing of the interactions of actors with other actors in the scene. Notable areas of the scene editor view 800 are the scene area 802, the inspector area 804, and media browser 806.

The inspector area 804 of the scene editor view 800 is where a game developer interacts with the working elements of the scene. There are two illustrative groupings—views related to the game as a whole, and views related to the scene. The two views can be accessed by clicking respective buttons 808 that enable switching of modes.

When the game button of buttons 808 is selected, the game developer may see actor pane 803 in the inspector area 804, as shown in FIG. 8. The actor pane 803 shows thumbnail images of the actor instance and the actor's label, such as actor and label indicated at 810. At the bottom left of the pane there are plus and minus buttons 812 that enable the game developer to add new actor instances or delete the selected actor, respectively. On the bottom right there is a drop down dialog box 814 that enables the game developer to choose from the existing tags in the system. Selecting a tag in the dialog box 814 filters the actor list, displaying only actors which contain the selected tag.

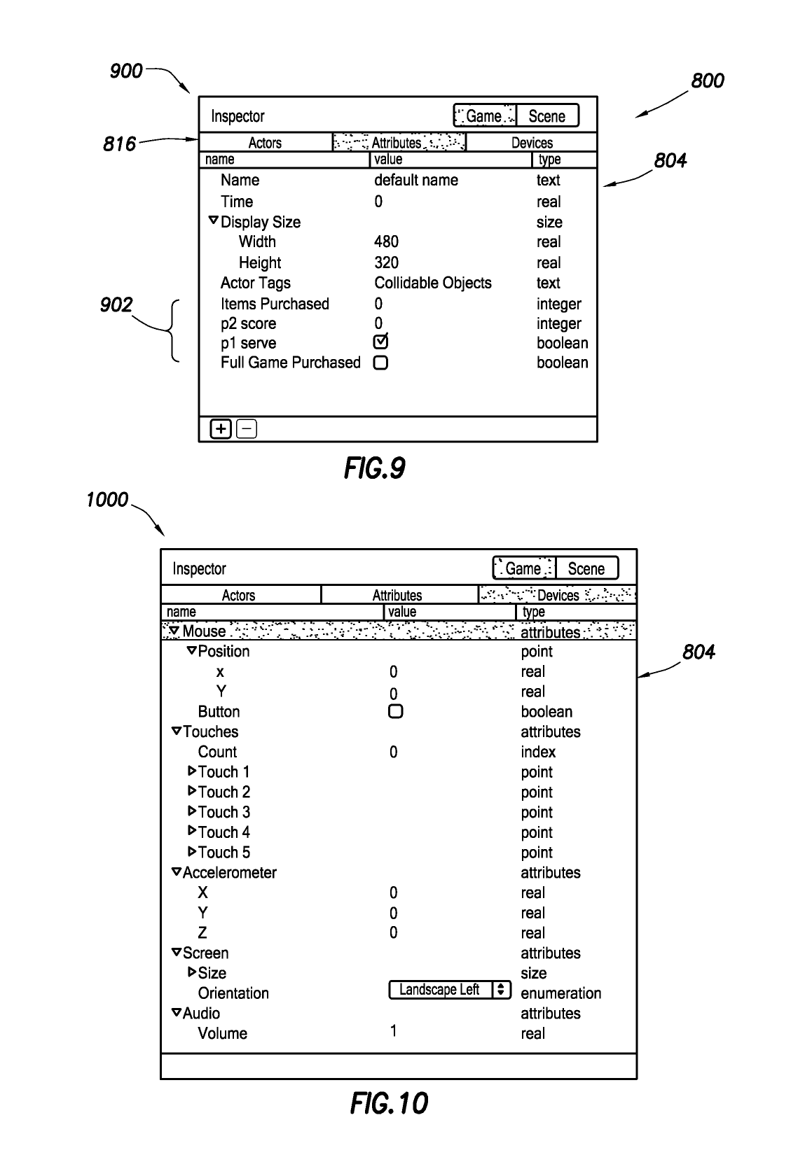

The inspector area 804 may also show a game attributes view, where selecting between the views involves interaction with buttons 816. FIG. 9 shows the inspector area 804 of the scene editor view 800 when the inspector area 804 shows the game attributes view 900. In particular, the game attributes view 900 enables the game developer to change attributes that apply to the whole game, as well as add new attributes 902 that can be used to store and share data during runtime. These new attributes include increasing or decreasing the inventory of purchasable items when an in-application purchase behavior is implemented, or an attribute may store whether the status of an actor is unlocked or locked.

Referring again to FIG. 8, the inspector area 804 may also show a game devices view, where selecting between the views again involves interaction with buttons 816. FIG. 10 shows the inspector area 804 of the scene editor view 800 when the inspector area 804 shows the game devices view 1000. In a particular embodiment, the game devices view 1000 gives a readable representation of the state of input and display hardware. For example, the game devices view 1000 may provide information such as current position of the mouse, last position of touch on the touch screen, current audio volume. In some cases, the game devices view 1000 does not enable changing of the values displayed.

Referring again to FIG. 8, the final element of the scene editor view 800 is the media browser 806. The media browser 806 has three views—behaviors view, images view, and audio view. The default view for the media browser 806 is the behaviors view 820 as shown in FIG. 8. The behaviors view 820 has several parts, such as behavior folders 822, the behavior (and actions) list 824, and in some cases a documentation pane that gives a brief explanation of each behavior and/or action. The behavior folders 822 section enables a game developer to select from either a set of behaviors provided by the game development system, or custom behaviors which the game developer has created. Depending on the folder selected, the appropriate set of behaviors is in the behavior list 824. In the scene editor view 800, a game developer may drag a behavior onto an actor in either the scene area 802 or the actor view 803 of the inspector area 804. Dragging the behavior to the actor changes default attributes and conduct of the actor. If the scene is executing in the runtime preview, the behavior will begin to take effect immediately. For example, a developer may create an in-application purchase behavior for a prototype actor by dragging and dropping an in-application purchase behavior element into the window and associating it with the prototype actor. The in-application purchase behavior has been previously defined by the developer who has input any and all information to initiate and execute the purchase, such as the name of an item, a unique identifying number, a description, a price, and any possible behavior elements that will trigger the in-application purchase behavior. The in-application purchase behavior can be linked with other behaviors and attributes within the scene. For example, in FIG. 8, a developer the in-application purchase behavior may be associated with the cannon such that after the cannon runs out of the cannonballs, the in-application purchase behavior is initiated enabling the player to purchase more cannonballs.

As discussed above with respect to prototype actors, the runtime engine 104 uses an inheritance model for actors. Each actor instance has one prototype, and a prototype may have many actor instances. By default an actor behaves as defined by its prototype actor. A particular instance of an actor may also be changed so that it behaves differently from the prototype actor. In accordance with at least some embodiments, when a player double clicks on an actor icon in the actor pane 803 of the inspector area 804, an actor editor view (discussed more below) displays attributes and/or conduct of the prototype actor. If game developer double clicks on an actor instance in the scene, the game developer may then be presented with a prompt to perform a positive action to unlock (or de-couple) the behaviors of the actor instance from the prototype actor. By unlocking the behaviors of an actor instance, the game developer overrides the prototype actor behavior and is free to modify the behaviors of the actor instance directly. From that point on, edits to prototype's behaviors with respect to overridden behaviors (or actions) will no longer affect the actor instance. Actor attributes also are inherited from the prototype actor. If the game developer changes an attribute of an actor instance, it will become overridden and no longer inherit values from the prototype. Actors that have inherited the behaviors and attributes of a prototype actor that do not include the in-application purchase behavior and associated attributes may still be modified at the scene level to include the in-application purchase behavior and any other associated behaviors and attributes and the scene level.

Actor Editor View

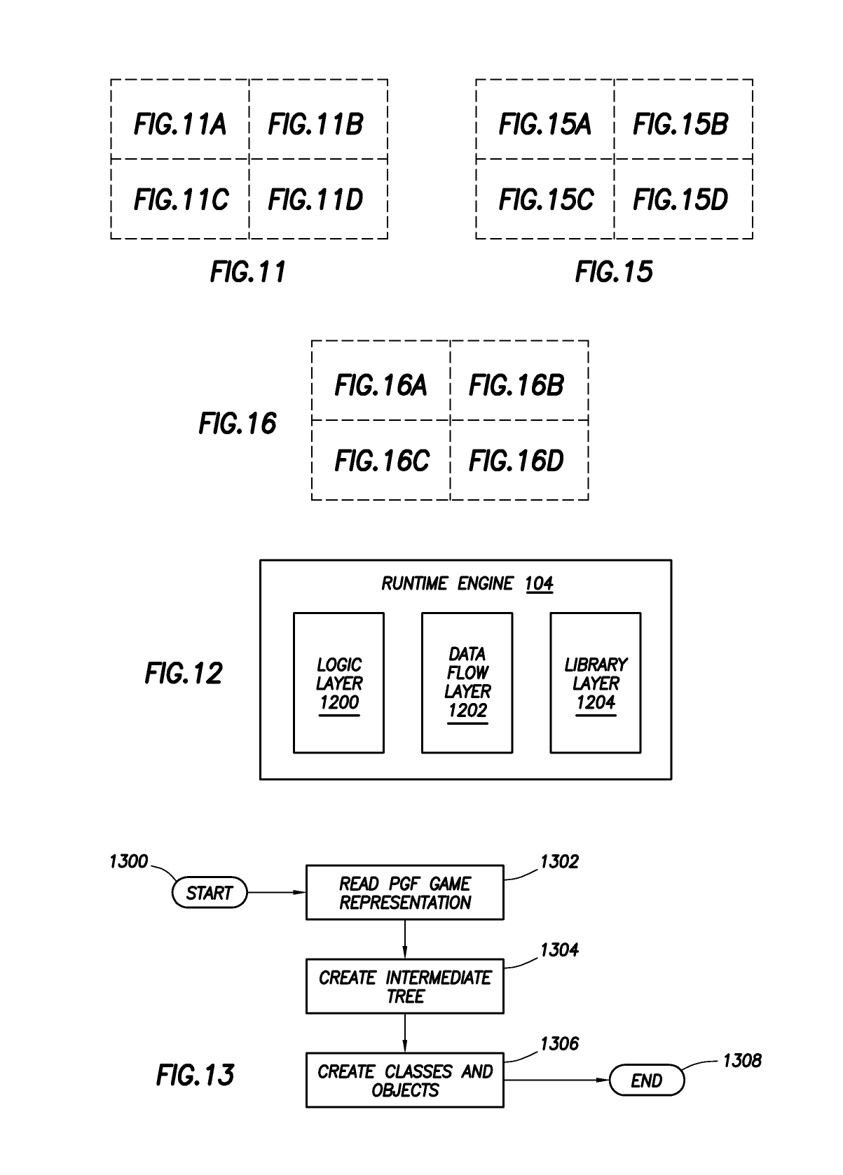

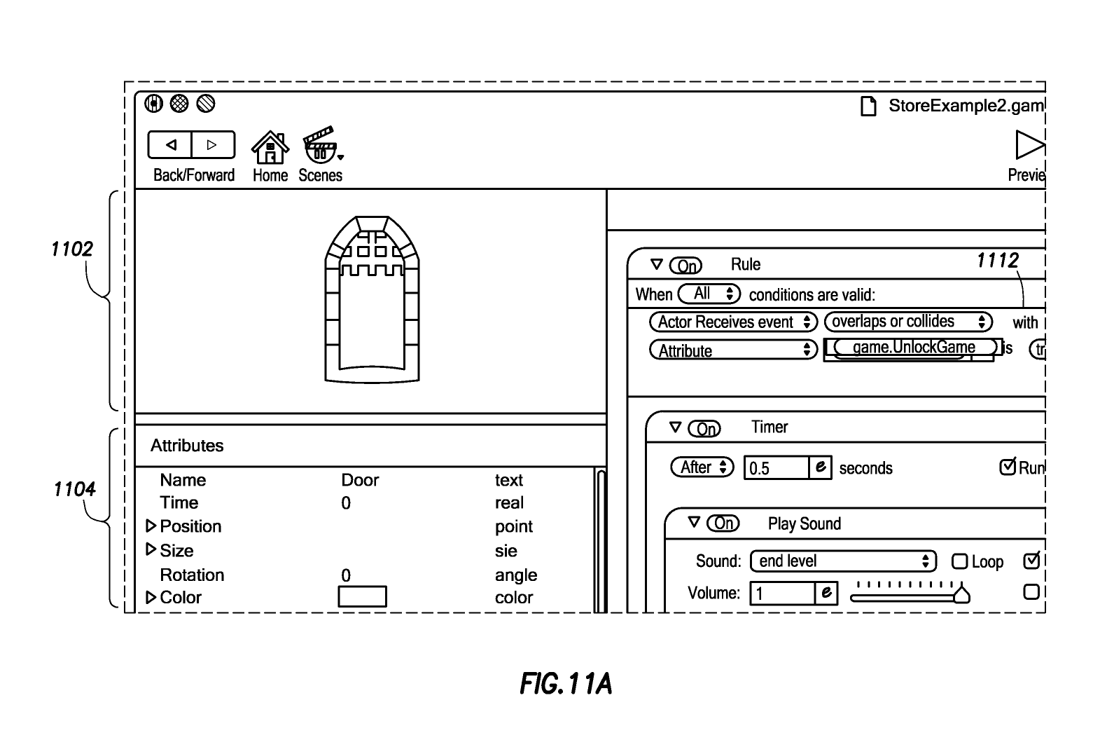

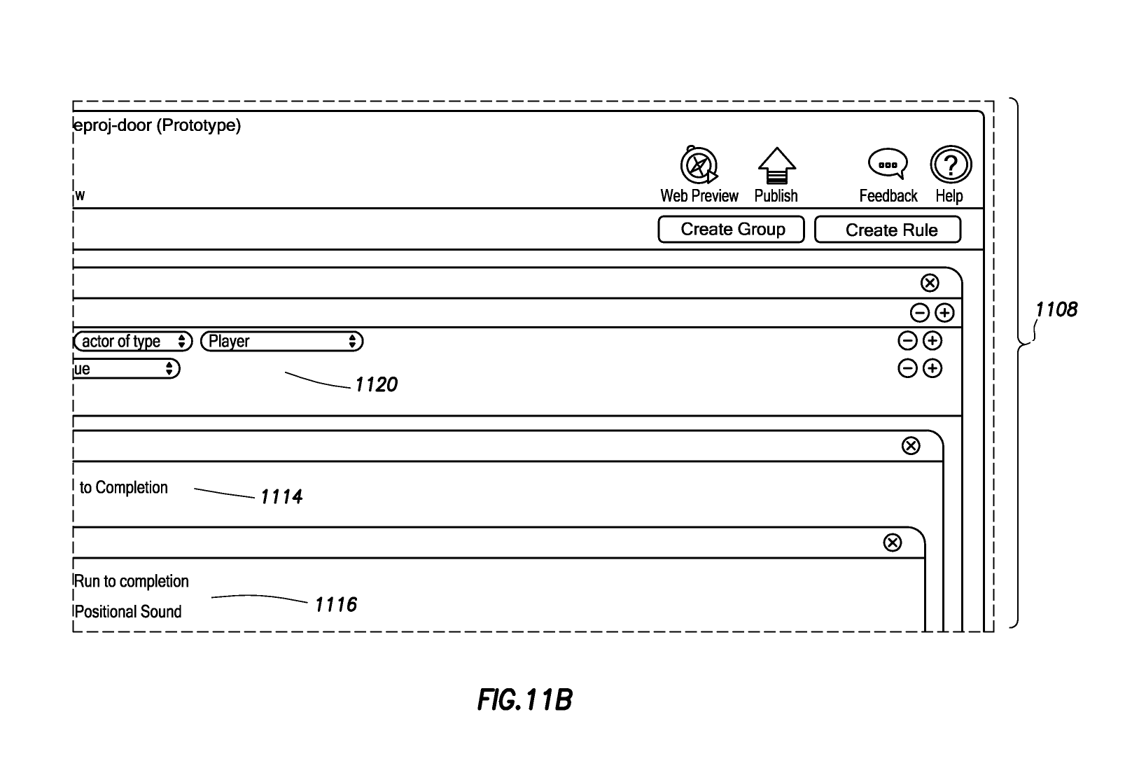

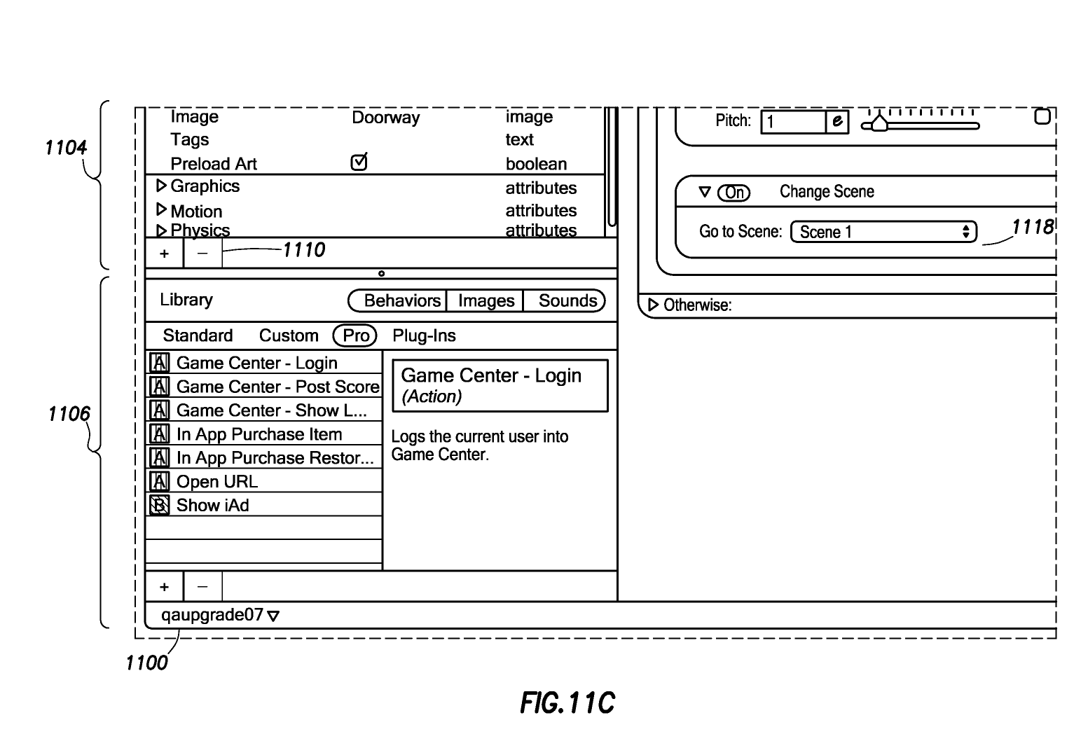

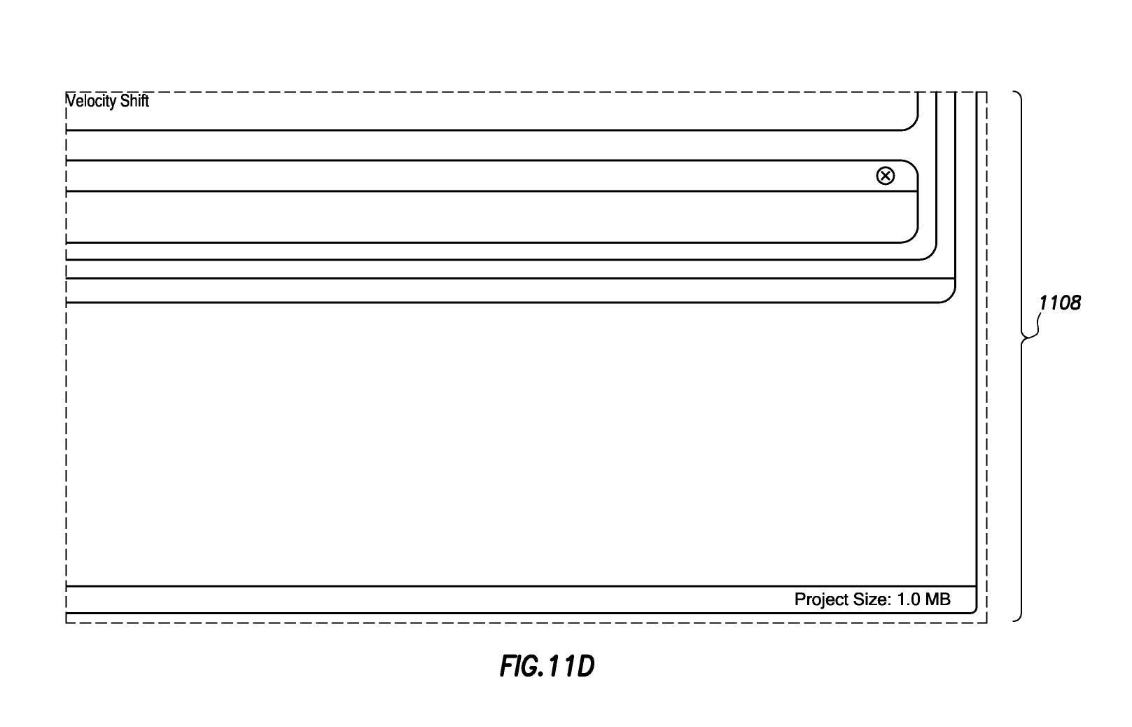

FIG. 11 shows an actor editor view 1100 of the project editor 100. The actor editor view 1100 is composed of four main panes—image pane 1102, the attributes pane 1104, the media browser pane 1106, and the behavior composer pane 1108. If the game developer is editing an actor instance, in addition to the illustrative panes shown in FIG. 11, three additional buttons appear: “Edit Prototype”, which enables the game developer to edit the instance's prototype; “Revert to Prototype”, which reverts the behaviors/actions of the actor instance to that of its prototype actor; and “Revert to Prototype”, which reverts a selected attribute back to the prototype actor.

Image pane 1102 displays a thumbnail image of the actor being edited, if an image has been associated with the actor. In cases where no image has been associated with the actor, such an associated may be made by dragging a selected image to the image pane 1102.

Attributes pane 1104 enables the game developer to edit the attributes of an actor, as well as add and remove custom attributes for the actor by pressing the plus and minus buttons 1110. Actors have a number of attributes which specify how they are displayed and behave as previously discussed. Attributes related to the in-application purchase behavior include increasing or decreasing an inventory status for an actor, or alternatively, increasing or decreasing an inventory status in the game as a whole, as opposed to being associated with a specific actor. An attribute may also be a Boolean value that describes whether a behavior or actor is locked or unlocked after an in-application purchase behavior is implemented. Additionally, a locked or unlocked attribute may relate to the game as a whole, as opposed to an actor or behavior specifically.

The media browser pane 1106 works much like the media browser pane 806 of the scene view editor 800. While behavior of the media browser pane 1106 may be no different than the media browser pane 806, the actor editor view 1100 presents different locations to which the behaviors (and actions) can be associated.

Within the actor editor view 1100 the behavior and actions of an actor are defined, specifically within the behavior pane 1108. In accordance with some embodiments, attaching an in-application purchase behavior to an actor may involve dragging the icon for the in-application purchase behavior from a list of behaviors in the media browser pane 1106 into the behavior pane 1108. Furthermore, if the game developer drags media icons from the media browser pane 1106 (e.g., images, audio) the project editor adds an appropriate behavior that matches the media.

In accordance with at least some embodiments, game flow or design is only defined in the context of an actor. Thus, a game designer declares that an actor behave a certain way by dragging a behavior and/or action from the behavior tab of the media browser pane 1106 into the behavior pane 1108. If a particular behavior is dragged into the top level of the behavior pane 1108, the particular behavior will evaluate at the start of runtime execution of the actor.

FIG. 11 shows a portion of an actor editor panel illustrating how a developer could create an in-application purchase behavior assigned to prototype actor Door. In this figure, the developer has created not only an in-application behavior, but has also associated it with three other behaviors which would activate upon a purchase. For example, the developer creates a Rule 1112, and three related behaviors: Timer 1114, Play Sound 1116, and Change Scene 1118. The developer has created a rule such that when game.UnlockGame is true 1120 (i.e. UnlockGame item has been purchased), the Timer behavior, the Play Sound behavior, and the Change Scene behavior would run.

Project Editor and PGF Game Representation

Before continuing, it may be helpful to an understanding of the various embodiments to highlight particular relationships of the portions discussed to this stage. In particular, the specification discussed the PGF game representation 102, and the project editor 100 (in particular, various scene and actor views), and it is to be understood that actions that take place in the graphical environment of the project editor 100 result in changes and additions in the PGF game representation. Every attribute and conduct (i.e., behaviors and/or actions) created or modified by the project editor 100 has a resulting representing in the PGF game representation.

Runtime Engine

The specification now turns to a more detailed description of the runtime engine. FIG. 12 shows in block diagram form the logical components of the runtime engine 104. While designated with respect to the runtime engine 104, the description is equally applicable to the illustrative runtime engines 200, 202, and 204. In particular, the runtime engine 104 may be considered to have three logical components: logic layer 1200; data flow layer 1202; and library layer 1204. Each of the illustrative layers will be discussed in turn.

The logic layer 1200 is a program or routine that performs initial steps in preparing to execute the game. FIG. 13 shows a method related to the logic layer 1200 in accordance with at least some embodiments. In particular, the method starts (block 1300) and proceeds to reading the PGF game representation (block 1302). In a particular embodiment, reading the PGF game representation involves reading a series of folders and files, where the files are coded in XML. From the PGF game representation, the illustrative method involves creating an intermediate tree (block 1304). The intermediate tree is a logical representation or organization of the game based on the prototype actors, scenes, and actor instances within the scenes. From the intermediate tree, the next step in the illustrative method is the creation of classes and objects (block 1306) of the game, and thereafter the method end (block 1308). In a particular embodiment, the classes and objects are created in the Lua programming or scripting language. Other programming languages may be equivalently used to create the classes and objects of the game, such as the C++ programming language, or Java® brand programming language. Stated otherwise, the PGF game representation is used as the basis to create classes and objects in an object oriented programming language.

The classes and objects that rely on hardware to determine values “register” with an event center object. The event center routine is the “clearinghouse” for routing data from the hardware (e.g., mouse position, accelerometer reading, inclinometer reading). As different values are received from the hardware devices, the data is dispatched to the appropriate classes and objects in the logic layer 1200. Each end device upon which an interactive game is played may have a different native “front end” that acts as the abstraction layer between the hardware and software, and thus each runtime engine is specifically designed to interface with the respective native front end. For example, when an in-application purchase behavior is implemented an event is detected by the native front end, which calls an appropriate application programming interface of the runtime engine. The application programming interface posts the event to the event center, and the event center delivers the event to any rules or behaviors that are registered to receive the data.

Returning to FIG. 12, the data flow layer 1202 is a program or routine that interfaces between the objects created by the logic layer 1200 and library layer 1204. The precise number of executable objects (nodes) in the data flow layer depends directly on the number of objects within a particular scene. However, the data flow layer 1202 can be considered to create executable code portions at runtime responsive to the scene and actors within the scene, and the data flow layer changes executable code with changes of scene, and in some cases with changes within a scene. Nodes may be created responsive to classes and/or objects at the logic layer, and the nodes created may read data from the logic layer and pass data directly to the library layer 1204, or nodes may pass data to other nodes within the data flow layer 1202. Thus, the data flow layer 1202 does not replace or supplant the logic layer 1200; rather, the data flow later 1202 relies upon the logic layer as the repository for data about the game (e.g., an actor's current position or velocity). Moreover, data flow through the data flow layer 1202 not only operates in the “push mode”, where changes at the logic layer are pushed through the data flow layer 1202, but also in a “pull mode”, where the library layer 1204 can trigger the data flow layer to read the latest data from the logic layer 1200.

The next illustrative layer is the library layer 1204. The library layer 1204 can be considered to serve at least two purposes—interface with the hardware upon which the game executes, and implement the physics engine. In particular, the library layer 1204 is or has the executable code or routines that interface with the particular hardware. For example, the library layer 1204 may interface with graphics hardware, such as making application programming interface (API) calls consistent with the Open Graphics Library (OpenGL) standard specification. As another example, the library layer 1204 may interface with sound hardware, such as making API calls consistent with the Open Audio Layer (OpenAL) API. The library layer 1204 may perform other tasks as well, as reading player input (e.g., reading keyboard entries, reading touch screen entries, reading device accelerometer, and reading device inclinometer).

The second illustrative purpose of the library layer 1204 is to implement the underlying physics engine for the game. In some embodiments, game play controlled or constrained under a rigid-body physics engine that approximates real-world physical interactions. Each actor configured to have physical interaction is simulated by the physics systems after the actors' behaviors and actions are evaluated.

In-Application Purchase Behavior

Various embodiments are directed to an in-application purchase behavior. The in-application purchase behavior has been referred to in previous paragraphs, and will now be described in more detail below.

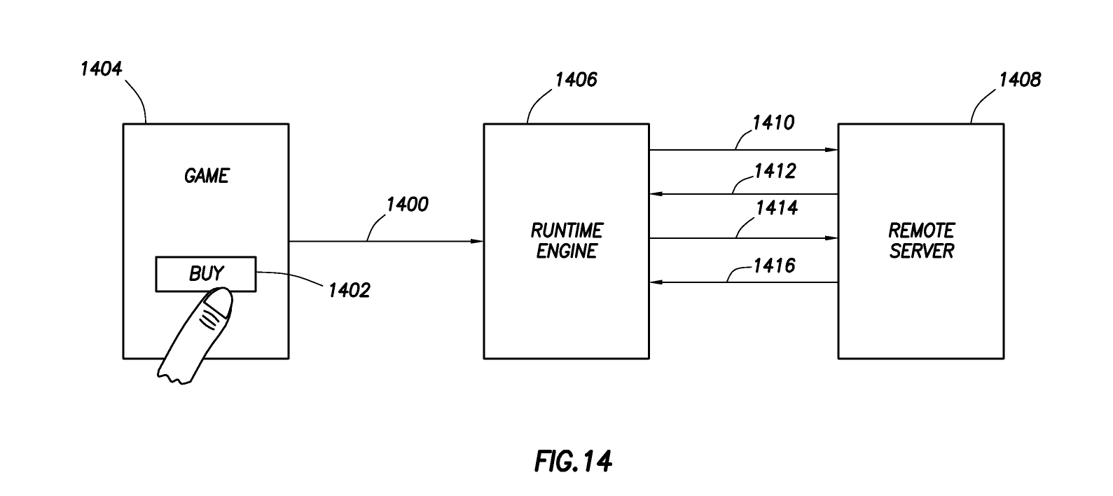

FIG. 14 illustrates a process that occurs when a player initiates an in-application purchase. A player interacting with application or game 1400 is given the opportunity to make a purchase. This opportunity could come by way of player interacting with an actor to purchase an item or behavior at a virtual storefront. Additionally, the opportunity could come by way of interacting with another actor, such as a merchant, or by way of an actor initiating another behavior, such as colliding with a supply ship. Any of these illustrative interactions may trigger a purchase opportunity, e.g., to buy additional speed or ammunition. In the example of FIG. 14, the player interacts with the in-application purchase by activating a button 1402 on a touch screen interface 1404 of the device.

Regardless of the precise mechanism by which an in-application purchase is triggered, when the player initiates the purchase 1400, the runtime engine 1406 first communicates with a remote server 1408, as shown by line 1410. The communication 1410 may be by way of any suitable communication protocol, and over any suitable communication channel, such as the Internet. The initial communication 1410 may certify a variety of information that could include verifying log-in credentials, whether log-in credentials are matched with the device identifier, the price of the purchasable item, and credit card information. Additionally, communication 1410 may verify the price with the remote server. Once the certification information and price is verified, the remote server communicates 1412 with the runtime engine indicating the purchase can proceed. The runtime engine then confirms the purchase and communicates again 1414 with the remote service to make a purchase request. If the remote server approves the request, the purchase is completed and the remote server communicates 1416 with the runtime engine to unlock the purchased item in the game, or to change the inventory of the purchased item.

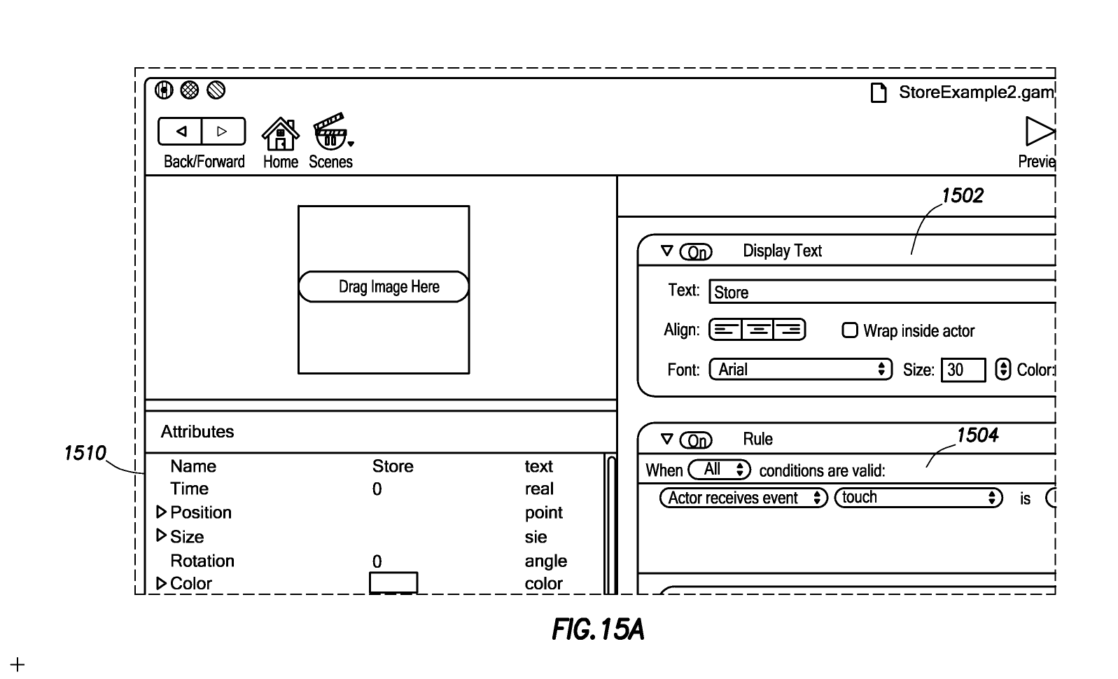

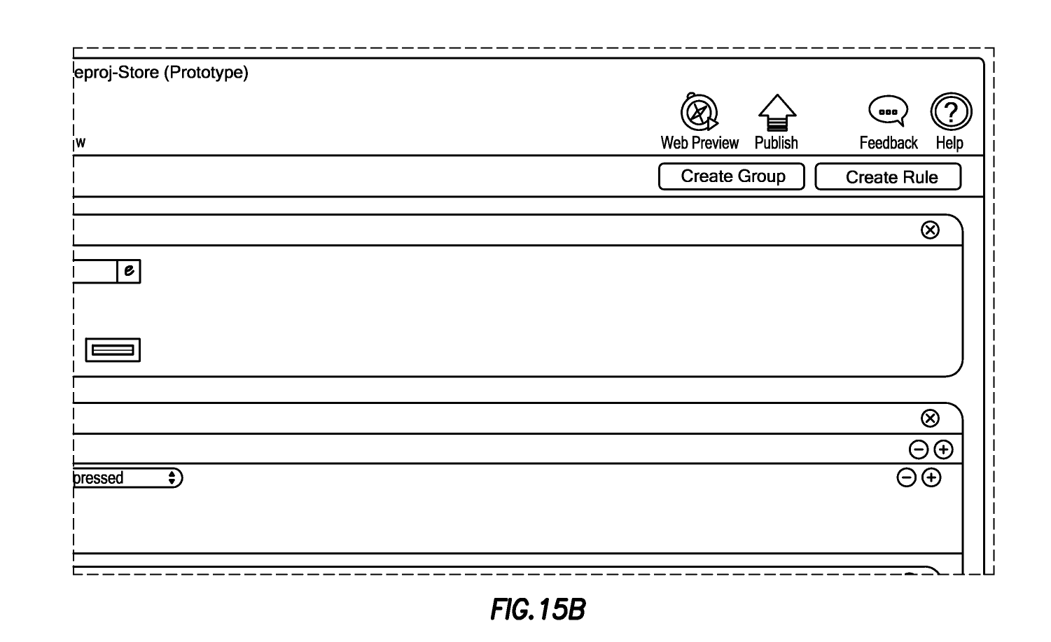

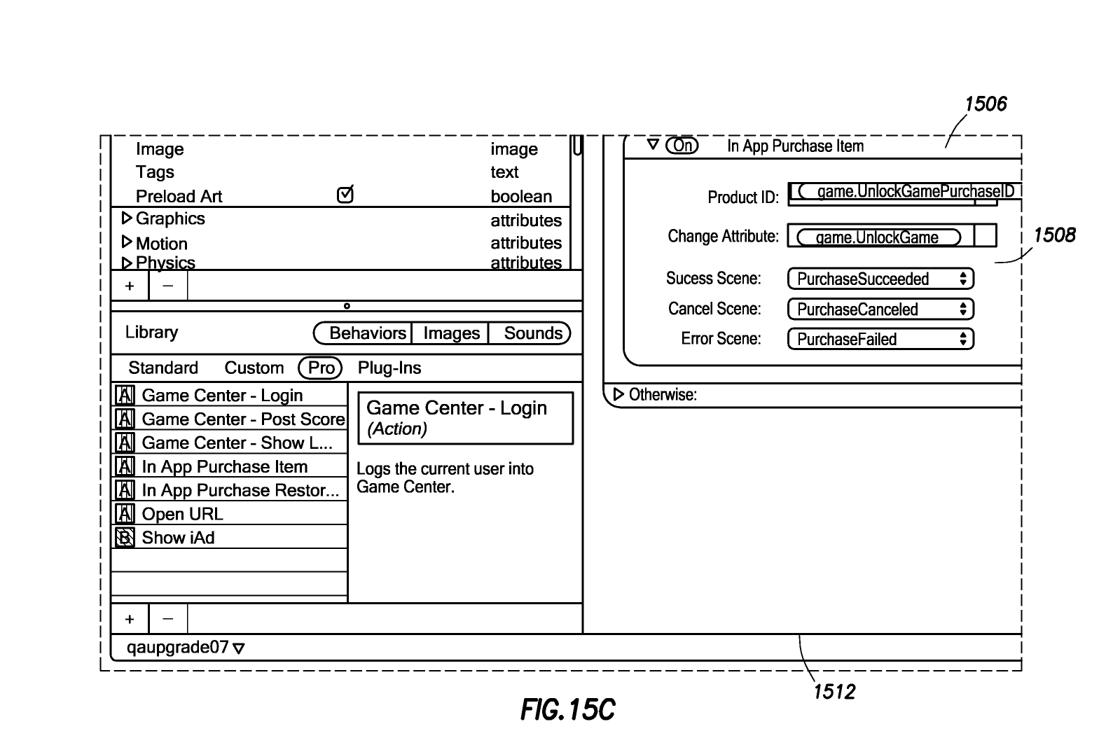

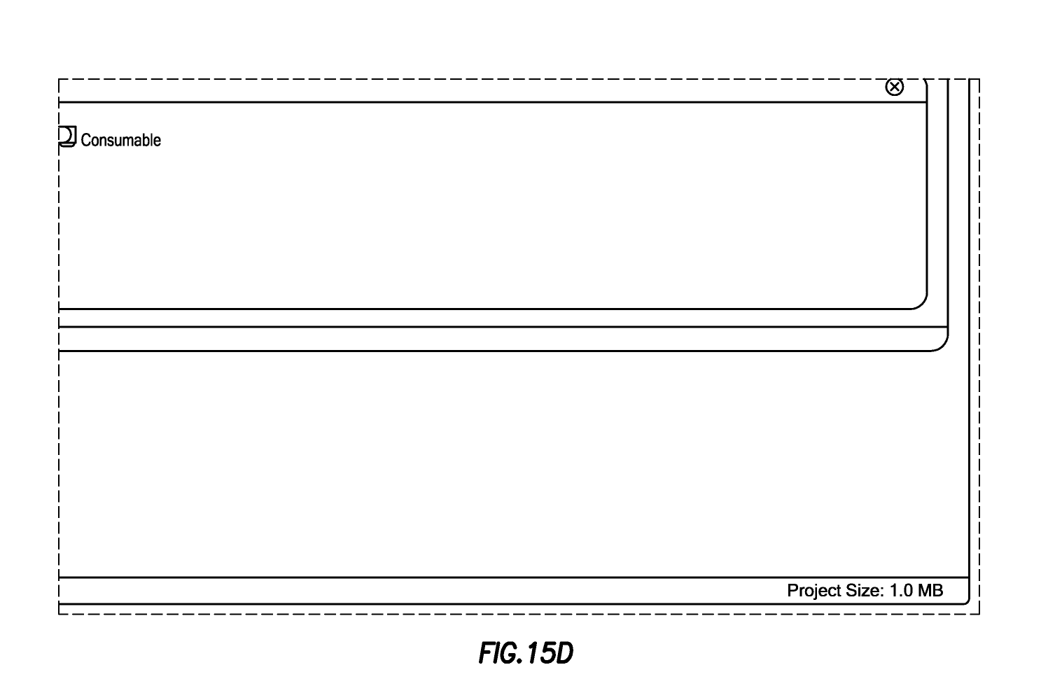

FIG. 15 shows a portion of an actor editor view, and illustrates how a developer would enable player to purchase an item without having to program any code. In panel 1512, the developer has dragged and dropped a series of rules relating to an actor selling an item. In this example, the actor is a store, and when the player clicks on the store, as indicated by Rule 1504, the “In App Purchase Item” behavior 1506 is activated. If the UnlockGame item is purchased by the player, the developer has indicated that the runtime engine should change the value of attribute 1508 associated with the “In App Purchased Item” behavior 1506, indicated by the name game.UnlockGame to true, indicating the UnlockGame item has been purchased. In addition, the developer can assign any number of variables to the actor with the in-application purchase behavior including but not limited to the position of the actor, its color, and any text associated with the actor, as seen in panel 1510.

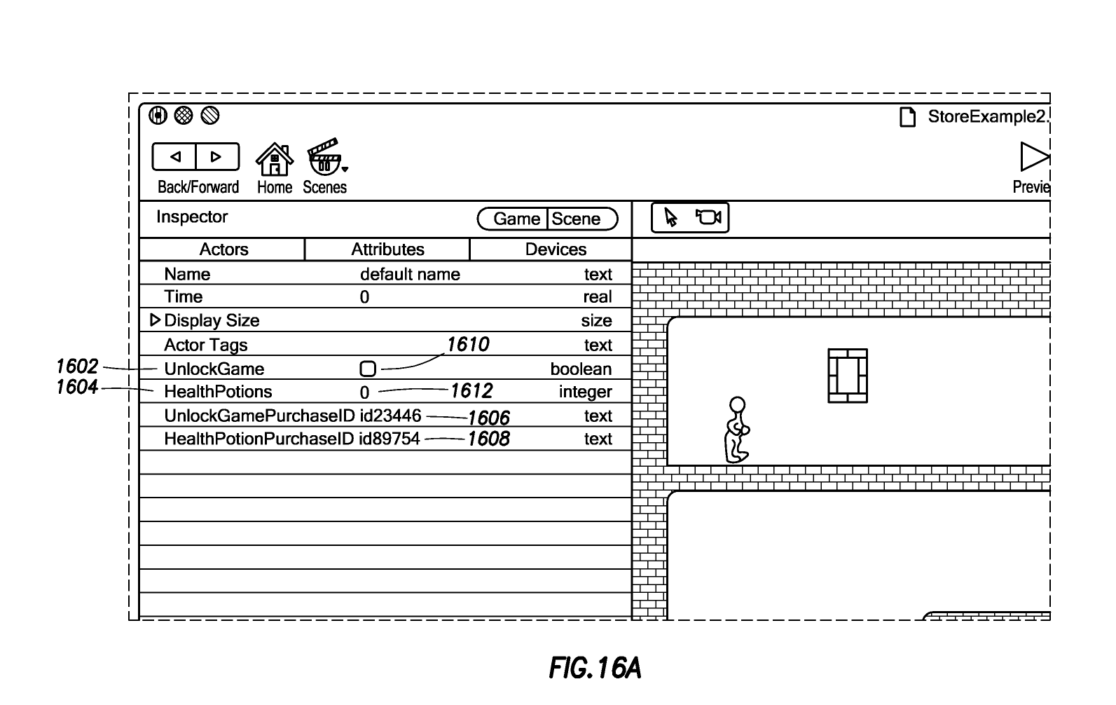

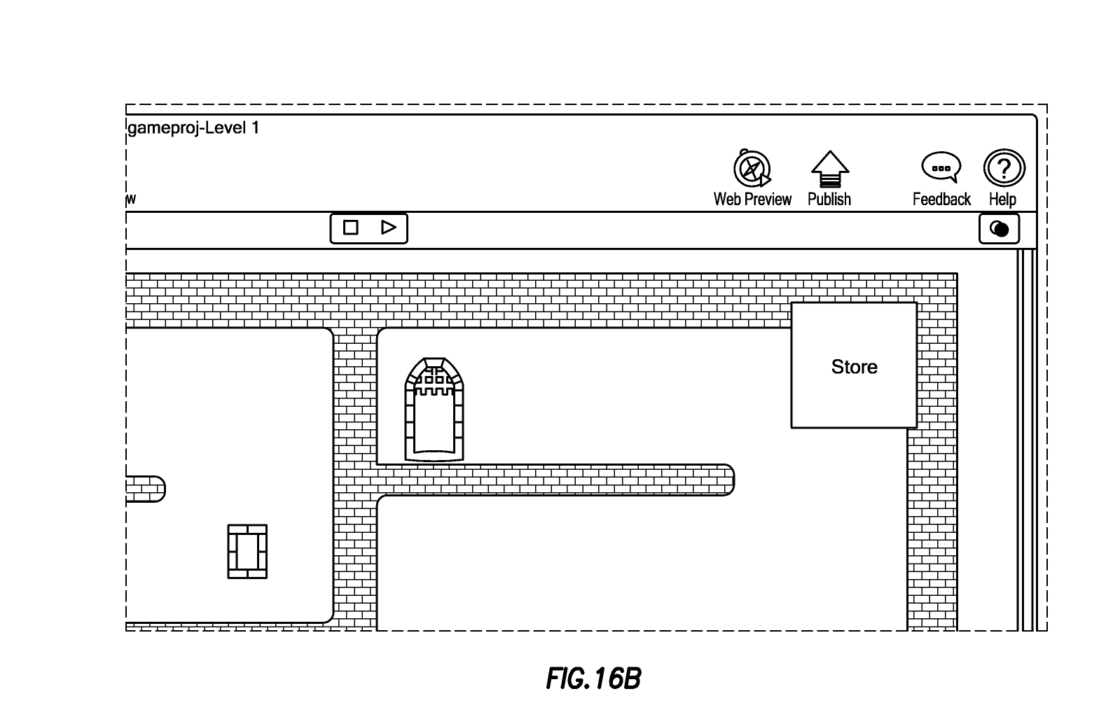

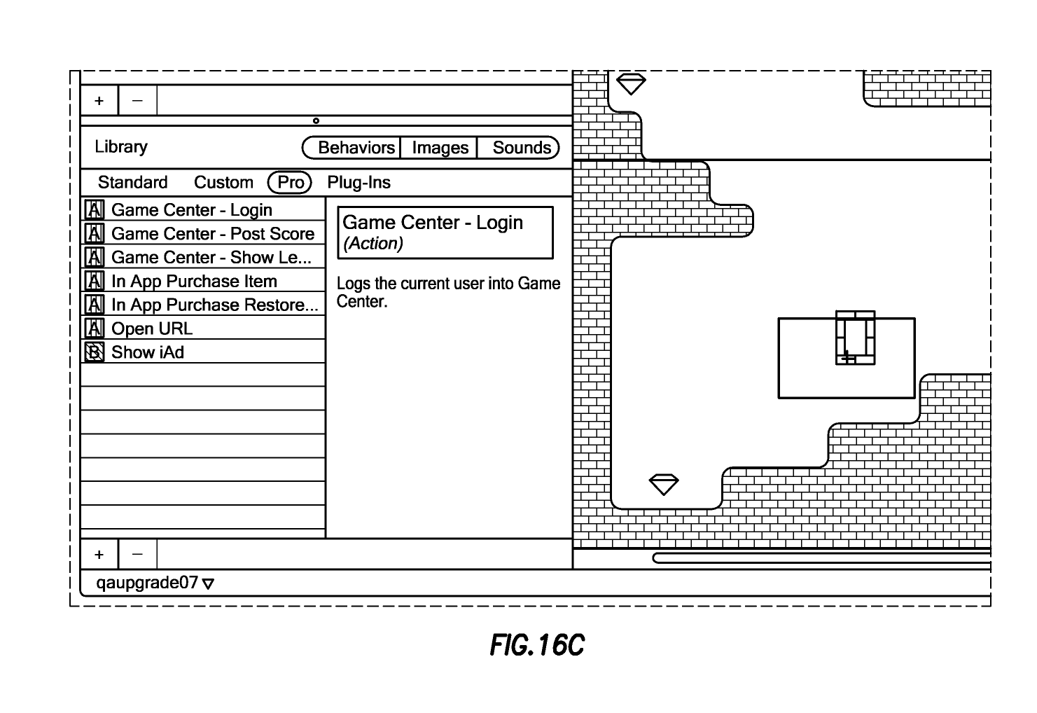

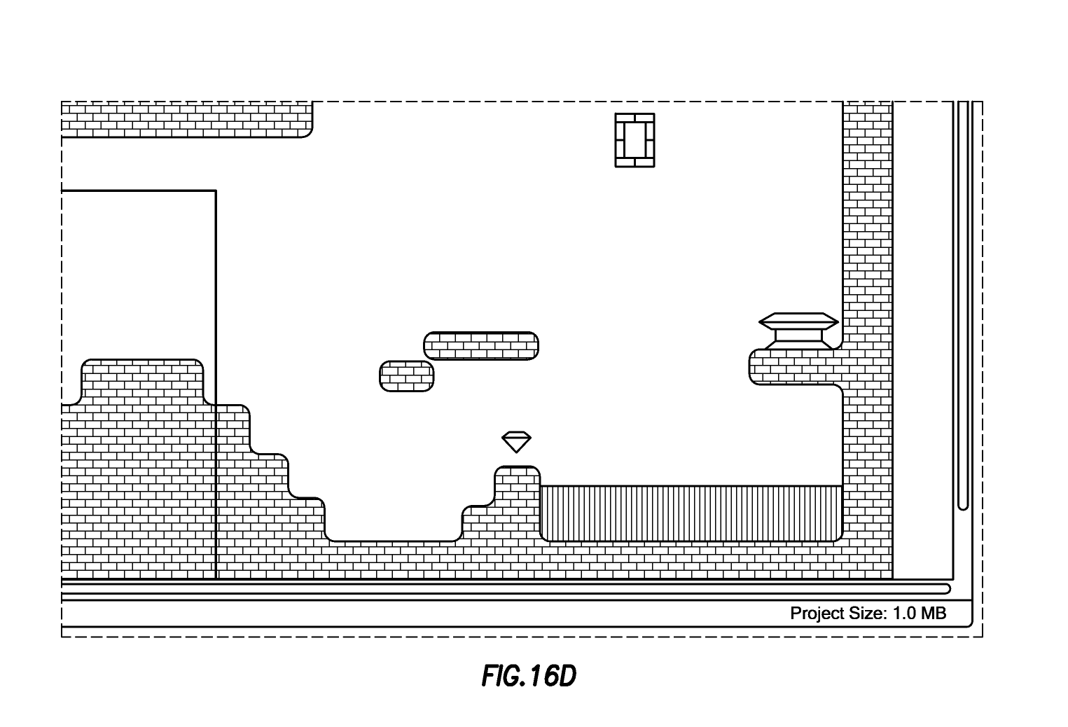

FIG. 16 shows initial setup steps a designer might make to create an in-application purchase behavior and to set up associated items and attributes. In this example, the developer has created two purchasable items: UnlockGame 1602 and HealthPotions 1604. When a developer wishes to create an item for purchase, the developer sets up that item with a third party provider (e.g. Apple), and in return, the third party provider gives the developer a unique identifier for the item. In this example UnlockGamePurchaseID is illustratively assigned number id23446, and HealthPotionPurchaseID is illustratively assigned number id89754.

For each item that can be purchased, the developer creates a pair of attributes. The first attribute stores the unique identifier received from the third party provider. In this example, the text attributes 1606 and 1608 store the unique identifiers for UnlockGame and HealthPotions, respectively. The second associated attribute stores the purchase status of the item. In the example of UnlockGame, the attribute is a Boolean; therefore, if the player has purchased the item, the attribute 1710 is set as “true”; otherwise, the attribute is “false.” In the example of HealthPotions, the attribute is an integer. Purchasing a health potion would cause the attribute 1712 to store an increased integer value.

Table 2 below illustrates what is created in the PGF game representation responsive to creating the illustrative in-application purchases. Referring to FIG. 5, the PGF representation of the in-application purchase behavior represented by example Table 2 may be stored in the “behaviors/” folder 506.

TABLE 2
<behavior id=“id463787” class=“InAppPurchaseItemAction”
enabled=“true”>

<attributes>

<text id=“name”>In App Purchase Item</text>
<text id=“bundleName”>InAppPurchaseItem.behavior</text>
<text id=“itemIdentifier”>game.attributes.id679072</text>
<text id=“targetAttribute”>game.attributes.id383616</text>
<boolean id=“consumable”>false</boolean>
<text id=“RHS”/>
<text id=“successSceneKey”>id253999</text>
<text id=“cancelSceneKey”>id481407</text>
<text id=“errorSceneKey”>id363262</text>

</attributes>

</behavior>

A purchase could unlock behaviors to the application, which may allow the player to access new scenes, actors, or behaviors. A purchase may also increase an inventory item. If the purchase item is an inventory item, the related attributes may increase or decrease to correctly update the inventory status of the item actor. In the example UnlockGame, when the purchase transaction is finished, the purchase status will be stored in the UnlockGame attribute. If the purchase is successful, the attribute will be “true”; if the purchase has failed or is canceled, the attribute will be “false.” Another purchase could allow a player to unlock a full version of the game, as opposed to a free trial game, or alternatively to unlock special levels, scenes, skins, or sounds.

There are a host of behaviors and actions that may be assigned to an actor in accordance with the various embodiments, including the in-application purchase behavior. An actor in a scene may have an associated attribute, such that when an in-application purchase behavior is implemented, the attribute increases, decreases, unlocks, or locks, where unlocking or locking is represented by a Boolean value. For example, in the space ship game, the player interacting with a space ship actor may steer the ship to a space station in which the game will prompt the player to purchase a booster pack. When the purchase is initiated, the inventory attribute of booster packs the space ship possesses increases, whereas the inventory attribute of booster packs the space station possesses decreases.

Example Computing Environment

The various embodiments discussed to this point operate on computer systems of varying forms. For example, the project editor 100 and runtime engine 104 may execute on a desktop or laptop computer system. The deliverables 206, 208, and 210 may execute on any appropriate hardware, such as an iPhone® or iPad® brand product.

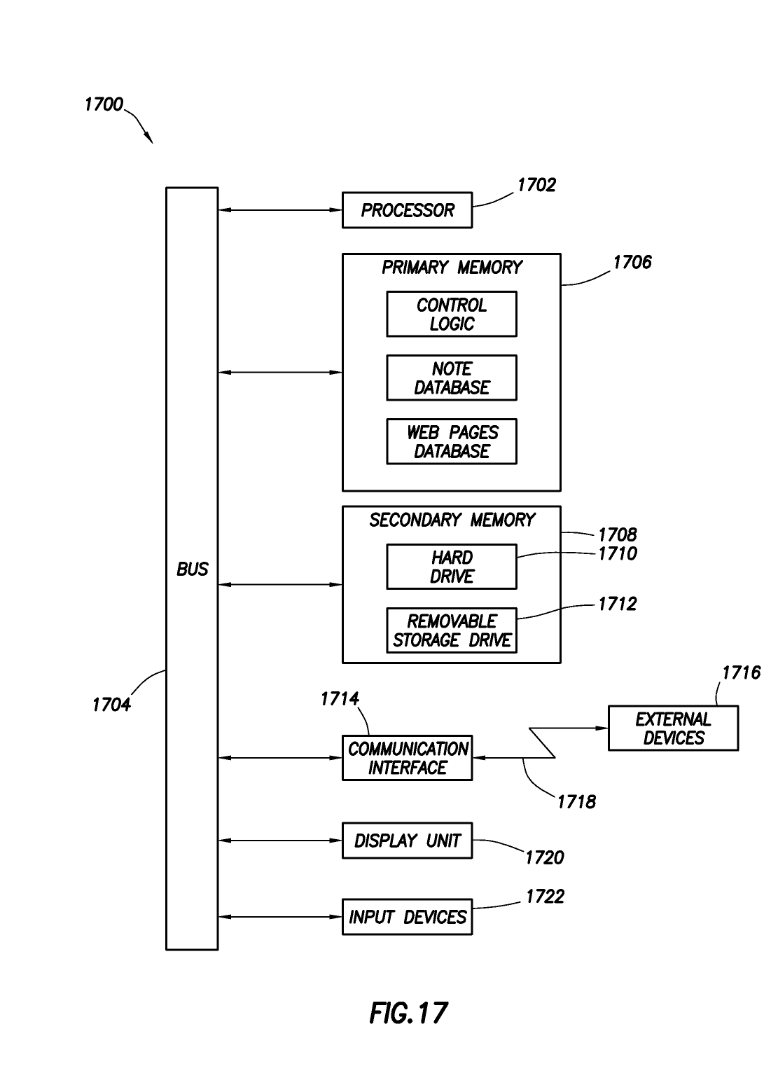

FIG. 17 shows an illustrative computer system 1700 in accordance with at least some embodiments. The illustrative computer system 1700 could be the environment on which the project editor 100 and runtime engine 104 are executed, and the illustrative computer system 1700 could be the computer system on which a specific deliverable 206, 208, and 210 may be executed. The computer system 1700 comprises one or more processors, such as a processor 1702. The processor 1702 is coupled to a communication bus 1704. The computer system 1700 also comprises a main or primary memory 1706. The computer system 1700 may also comprise a secondary memory 1708. The secondary memory 1708 may, for example, a hard disk drive 1710 and/or a removable storage drive 1712. Both the primary memory 1806 and the secondary memory 1708 are examples of computer-readable mediums upon which programs (executable by the processor 1702) may be stored. Moreover, the primary memory 1706 and the secondary memory 1708 are examples of computer readable mediums upon which PGF game representations may be stored.

The illustrative computer system 1700 may also comprise communication interface 1714. The communications interface 1714 enables the computer system 1700 to communicate and interact with locally or remotely located external devices 1716 via a communications medium 1718. In particular, communications interface 1714 enables the computer system 1700 to send and receive software and data to/from the external devices 1716. Examples of the communications interface 1714 comprise a modem, a network interface (such as a wired or wireless Ethernet card or a cellular card), a communications port, etc. The illustrative computer system 1700 may also comprise a display unit 1720, such as a computer monitor, and one or more input devices 1722, such as a keyboard and a pointing device (such as a mouse, trackball, etc.). One skilled in the art will readily recognized that the components described herein are employed in numerous computing devices, including, without limitation, personal computers, cell phones, portable music players that incorporate display, and tablet computers.

Behaviors and Actions

The following is a list of illustrative behaviors that may be associated with actors in the various embodiments.

Accelerate behavior—The Accelerate behavior specifies the acceleration and direction (angle) of an actor. The Accelerate behavior can be used in conjunction with a rule or trigger that is specifiable by the player (e.g., the in-application purchase behavior allows an actor to purchase the ability to accelerate faster). When activated, the Accelerate behavior accelerates the actor until the maximum define speed is achieved. It is noted that since the Accelerate behavior is directional, and thus acceleration in an opposite direction to a current motion may result initial in deceleration, followed by acceleration.

Animate behavior—The Animate behavior enables animating a series of images (at a particular frame rate). The animation of the series of images may be set to loop (play on a continuous loop), stop at the last frame, or return to the last image before the Animate behavior is triggered. The Animate behavior could be triggered when an in-application purchase behavior is implemented, animating the purchase itself (e.g. acceptance of a purchased item by an actor) within the scene.

Change Attribute action—The Change Attribute action enables the setting, change or incrementing of an attribute associated with an actor. For example, Change Attribute may be used to increase/decrease a value associated with the actor (e.g., inventory of item purchased), or may be used to change the status of an attribute that has been locked or unlocked upon the implementation of an in-application purchase behavior.

Change Image action—The Change Image action enables changing the image associated with the actor based on the occurrence of an event such as the implementation of the in-application purchase behavior. For example, a player may purchase a new skin for an actor.

Change Scene action—The Change Scene action enables the game to change to a different scene based on the occurrence of an event such as the implementation of the in-application purchase behavior. For example, a player playing the space ship game may purchase a bonus level which takes him to a new planet scene.

Change Size action—The Change Size action enables changing the physical size of the actor as rendered on the screen in response to the scale factor. The Change Size action includes growth in size of an actor (e.g., by a positive scale factor) and shrinking size of an actor (e.g., by a negative scale factor). The Change Size action may be based on the implementation of the in-application purchase behavior. For example, a player may purchase a bigger space ship that will have more ammunition storage capabilities.

Change Velocity action—The Change Velocity action enables movement of an actor at a particular velocity, the movement relative to the actor or to the scene, and which may be changed when purchased through the implementation of the in-application purchase behavior, such as giving the player the ability to travel at a higher velocity.

Collide behavior—The Collide behavior enables actors or group of actors to collide with one another in elastic-style collisions. The in-application purchase behavior may initiate upon an actor in a scene colliding with another actor in a scene through the Collide behavior.

Group behavior—The Group behavior creates a logical grouping of behaviors and actions. Behaviors and actions within the group still operate based on their respective triggers.

Load Attribute action—The Load Attribute action enables reading a value from a persistent storage device, and loading the value into an attribute of an actor.

Move behavior—The Move behavior enables the movement of an actor at a particular angle relative to the actor or to the scene.

Move To behavior—The Move To behavior enables movement of an actor toward a specific X,Y coordinate relative to the actor or the scene. The Move To behavior can be configured to run to completion, or can be controlled based on a parameter such that the movement toward the final location starts and stops as a function of other conditions.

Replicate behavior—The Replicate behavior enables replication of an actor within a scene based on the occurrence of an event. The number of copies created in the replication is settable directly or through an expression. A player may initiate a Replicate behavior by implementing the in-application behavior which affects the number of times the Replicate behavior replicates an image based on the number of items purchased.

Rule behavior—The Rule behavior creates condition or set of conditions to check for player input or attribute changes of an actor. The Rule behavior can be the triggering event for other behaviors and actions, such as the in-application purchase behavior, or can define input information for operation of other behaviors, such as a Move To location. Stated otherwise, the Rule behavior activates or deactivates other behaviors and actions.

Spawn Actor action—The Spawn Actor action creates a new actor instance within the scene, and enables specifying attributes of the new actor instance, such as direction of movement, angular position relative to the scene or spawning actor. The Spawn Actor action may generate an actor containing an in-application purchase behavior, allowing the player to purchase additional items within the scene or game. For example, in the space ship game, the Spawn Action action may create a merchant actor in the scene.

Stop Music action—The Stop Music action stops any current music that is playing. When an in-application purchase behavior is initiated, it may also initiate the Stop Music action while the purchase event is being completed.

Timer behavior—The Timer behavior enables performance of other behaviors (such as Rules or the in-application purchase behavior) at specified intervals. The specified intervals include: after a predefined or selectable number of seconds; every predefined or selectable number of seconds; and for a predefined or selected number of seconds.

Unpause Game action—The Unpause Game action removes the pause screen, restores the game to the previous scene, and resumes the game. After a purchase initiated by the implementation of an in-application purchase behavior, the Unpause Game action may be executed which allows the player to return to the game play.

From the description provided herein, those skilled in the art are readily able to combine software created as described with appropriate general-purpose or special-purpose computer hardware to create a computer system and/or computer sub-components in accordance with the various embodiments, to create a computer system and/or computer sub-components for carrying out the methods of the various embodiments, and/or to create a non-transitory computer-readable storage medium (i.e., other than an signal traveling along a conductor or carrier wave) for storing a software program to implement the method aspects of the various embodiments.

The above discussion is meant to be illustrative of the principles and various embodiments of the present invention. Numerous variations and modifications will become apparent to those skilled in the art once the above disclosure is fully appreciated. For example, while the various software components have been described in terms of game creation, the development context shall not be read as a limitation as to the scope of the one or more inventions described—the same techniques may be equivalently used for non-game programming. That is, the programming interfaces, portable format, and execution engine operation are equally applicable to any interactive multimedia application development, such as interactive books, interactive novels, educational tools, and animation. It is intended that the following claims be interpreted to embrace all such variations and modifications.

We claim:

1. A method comprising:
accepting an indication of flow of an interactive application configured to selectively implement an in-application purchase, the accepting by way of a graphical user interface (GUI) of an interface program executed on a computer system, and the indication at least partially in a declarative format;
creating a representation of the flow of the interactive application, the representation within a file accessible by the computer system, the representation at least partially in a declarative format, and the creating by the interface program; and
executing the interactive application by a first runtime engine, the first runtime engine becomes executable code that implements the in-application purchase by communicating with a device remote from a computer system on which the first runtime engine executes.

2. The method of claim 1 wherein executing further comprises interacting with a user by way of an actor of the interactive application, which actor implements the in-application purchase.

3. The method of claim 1 wherein executing further comprises:
interacting with a user by way of a first actor of the interactive application; and
implementing the in-application purchase based on the first actor interacting with a second actor within the interactive application.

4. The method of claim 1 wherein executing the interactive application implementing the in-application purchase further comprises at least one selected from the group consisting of: increasing an attribute; and decreasing the attribute.

5. The method of claim 1 wherein executing the interactive application that implements the in-application purchase further comprises at least one selected from the group consisting of: locking an attribute; and unlocking the attribute.

6. The method of claim 1 wherein executing the interactive application that implements the in-application purchase further comprises at least one selected from the group consisting of: locking an actor attribute; and unlocking the actor attribute.

7. The method of claim 1 wherein executing the interactive application that implements the in-application purchase further comprises at least one selected from the group consisting of: locking a game attribute; and unlocking the game attribute.

8. The method of claim 1 wherein creating the representation further comprises:
creating a representation of a prototype actor in an actor file;
creating an indication in the actor file that the prototype actor selectively implements the in-application purchase; and
creating an indication in the actor file of a purchase attribute related to the in-application purchase.

9. A method comprising:
executing an interactive application on a computer system comprising:
receiving an indication of design of the interactive application, the interactive application selectively implements an in-application purchase, the indication of design not directly executable by the computer system, and the indication of the interactive application not depicted in a programming language; and then creating an indication of objects of the interactive application in an object oriented programming language, the creating based on the indication of design;
executing node routines, each node routine instantiated based on one or more of the objects; and
implementing, by at least some of the node routines, communication with a remote device to facilitate an in-application purchase.

10. The method of claim 9 wherein receiving an indication of design of the interactive application further comprises receiving an indication of selective implementation of the in-application purchase coded in extensible markup language (XML).

11. The method of claim 9 wherein receiving an indication of design of the interactive application further comprises receiving an indication of selective implementation of the in-application purchase coded in Java Script Object Notation (JSON).

12. A non-transitory computer-readable medium storing a program that, when executed by a processor, causes the processor to:
read a representation of an interactive application from the computer-readable medium, the interactive application including a behavior configured to implement an in-application purchase, the representation not directly executable by the processor, and the representation the interactive application not depicted in a programming language; and then
configure the processor to execute consistent with the representation the interactive application, and when the processor executes consistent with the representation of the interactive application, the program causes the processor to:
create an indication of objects of the interactive application in an object oriented programming language;
execute node routines, each node routine instantiated based on one or more of the objects; and
implementing, by at least some of the node routines, communication with a remote device to facilitate an in-application purchase.

13. The non-transitory computer-readable medium of claim 12 wherein when the processor reads the representation of the interactive application, the program further causes the processor to read the representation of the interactive application coded in extensible markup language (XML).

14. The non-transitory computer-readable medium of claim 12 wherein when the processor reads the representation of the interactive game, the program further causes the processor to read the representation of the interactive application coded in Java Script Object Notation (JSON).

15. A computer system comprising:
a processor;
a memory coupled to the processor;
a display device coupled to the processor;
an interface device coupled to the processor;
wherein the memory stores a program that, when executed by the processor, causes the processor to:
accept, by way of the display device and the interface device, an indication of flow of an interactive application configured to selectively implement an in-application purchase, the indication at least partially in a declarative format;
create a representation of the flow of the interactive application, the representation within a file accessible by the computer system, and the representation at least partially in a declarative format; and
execute the interactive application, the representation of the flow executable code that implements the in-application purchase by communicating with a device remote from the computer system.

16. The computer system of claim 15 wherein the program further causes the processor to interact with a user by way of an actor which implements the in-application purchase behavior.

17. The computer system of claim 15 wherein the program further causes the processor to
enable a user to interact with a first actor in a scene; and
interact, by the first actor, with a second actor in the scene, which interaction implements an in-application purchase behavior.

18. The computer system of claim 15 wherein when the in-application purchase behavior is implemented, the program further causes the processor to at least one selected from the group consisting of: increase a game attribute; and decrease the game attribute.

19. The computer system of claim 15 wherein when the in-application purchase behavior is implemented the program further causes the processor to at least one selected from a group consisting of: increase an actor attribute; decrease an actor attribute; and change an actor status.

20. The computer system of claim 19 wherein the actor status is a Boolean attribute.

21. The computer system of claim 15 wherein when the in-application purchase behavior is implemented the program further causes the processor to at least one selected from a group consisting of: lock an attribute; and unlock an attribute.

22. The computer system of claim 15 wherein when the in-application purchase behavior is involved the program further causes the processor to at least one selected from a group consisting of: lock a game attribute; and unlock a game attribute.

23. The computer system of claim 15 wherein when the in-application purchase behavior is implemented the program further causes the processor to at least one selected from a group consisting of: lock an actor attribute; and unlock an actor attribute.

24. The computer system of claim 15 wherein when the in-application purchase behavior is implemented the program further causes the processor to make available another actor within the interactive application.

25. The computer system of claim 15 wherein when the processor creates the representation, the program further causes the processor to:
create a representation of an in-application purchase behavior; and
create a representation of an attribute.

26. The computer system of claim 23 wherein when the processor creates the representation of the attribute, the program further causes the processor to create a representation of the attribute associated with an actor.
